(19) United States
(12) Patent Application Publication
(10) Pub. No.: US 2019/0371117 A1
(43) Pub. Date: Dec. 5, 2019

(54) GAMING SYSTEM AND METHOD HAVING FREE SPINS WITH CASCADING AND LOOPING WINS

(71) Applicant: ADP GAUSELMANN GMBH, Espelkamp (DE)

(72) Inventors: Charles Hiten, Lighthouse, FL (US); Michael Charles Halvorson, Las Vegas, NV (US)

(21) Appl. No.: 16/456,272

(22) Filed: Jun. 28, 2019

Related U.S. Application Data
(63) Continuation-in-part of application No. 15/983,697, filed on May 18, 2018.
Application No. 15/983,697 is a continuation of application No. 15/858,629, filed on Dec. 29, 2017.

(51) Int. Cl. G07F 17/32

(52) U.S. Cl. CPC G07F 17/3213; G07F 17/3267; G07F 17/3288; G07F 17/3258; G07F 17/3241; G07F 17/323; G07F 17/3246; G07F 17/3248; G07F 17/3251; G07F 17/3227

(57) ABSTRACT

Gaming systems and methods are disclosed the provide a game feature having a repeating free spin win accumulator. Upon a triggering event, the gaming system can unlock a quantity of symbol displays areas of a game screen. For one or more of the unlocked symbol display area, the gaming system can randomly determine and display a symbol from an associated set of symbols. The gaming system accumulates awards based on the randomly determined symbols in the unlocked symbol display areas. The gaming system may lock unlocked symbol display areas in which the displayed symbol is a predetermined lock symbol. The gaming system may repeat the process for the play of a game until all symbol display areas are locked.

### CROSS-REFERENCES TO RELATED APPLICATIONS

The present application claims priority under 35 U.S.C. § 120 as a Continuation-in-Part of prior U.S. patent application Ser. No. 15/983,697, filed May 18, 2018, which is a continuation of the U.S. patent application Ser. No. 15/858,629, filed Dec. 29, 2017, the contents of which are incorporated herein in their entireties.

### FIELD

The present disclosure relates to gaming systems.

### SUMMARY

The present disclosure is directed to systems and processes for gaming. A gaming system consistent with implementations disclosed herein provides a game that randomly determines symbols and displays such symbols to players using a game display device. The gaming system evaluates the displayed symbols to determine whether they correspond to predetermined awards.

Various implementations of the systems and processes disclosed herein involve a repeating free spin win accumulator associated with unlocked symbol display areas. In some implementations, the gaming system accumulates wins in a predetermined format. In some implementations, the predetermined format for accumulated wins is a waterfall or cascading format. In implementations including the repeating free spin win accumulator, a gaming system may provide a game in which a game screen includes a plurality of symbol display areas that display symbols. Upon a triggering event, one or more of the symbol display areas are set to an unlocked state for a play of a game. In some implementations, the triggering event may include the gaming system generating at least one predetermined triggering symbol among the symbols displayed in the symbol display areas. For each symbol display area that is unlocked, the gaming system randomly generates and displays at least one symbol from one or more sets of symbols. Each symbol from the sets of symbols may be associated with an award or value. In some implementations, the gaming systems converts symbols of the unlocked symbol display areas to credit symbols representing monetary values. The conversion may be based on a predetermined correspondence between games symbols and respective credit symbols. Additionally, in some implementations, each unlocked symbol display area is associated with one set of symbols (e.g., a set of credit symbols). In some implementations, the gaming system randomly generates and displays the at least one symbol for each unlocked symbol display area in a predetermined format.

In accordance with aspects of the present disclosure, implementations of the gaming system may determine if a lock symbol was generated in any of the unlocked symbol display areas. In one such implementation, where the gaming system determines that lock symbols were generated in unlocked symbol display areas, the gaming system locks such symbol display areas from receiving additionally generated symbols from the sets of symbols for remainder of the game. The gaming system also evaluates the generated symbols in the symbol display area to determine an accumulated award. In some implementations, if any symbol display areas remain unlocked, the gaming system may repeat the above noted process for the play of the game until all symbol display areas are locked. That is, the gaming system may randomly generate and display at least one symbol for each remaining unlocked symbol display area. In alternative implementations, if any symbol display areas remain unlocked, the gaming system may repeat the process a predetermined number of times, such as five times (or some alternative suitable number of times). In some implementations, if any symbol display areas remain unlocked, the gaming system may repeat the process a predetermined number of times based in part on a player's wager or based on part on a triggering event.

In some implementations including the repeating free spin win accumulator, a gaming system may include a plurality of symbol display areas associated with a plurality of video-based slot machine reels. For example, the gaming system may include five video-based slot machine reels that are each associated with three symbol display areas. The gaming system further includes a first symbol set that includes a first plurality of symbols. The gaming system generates a plurality of symbols from the first symbol set for the plurality of symbol display areas. The gaming system evaluates the generated plurality of symbols for winning symbol combinations. The gaming system also evaluates the generated plurality of symbols for triggering symbols. If the gaming system determines that at least one triggering symbol was generated, one or more of the symbol display areas are set to an unlocked state for a play of a game. In some implementations, one triggering symbol may cause the gaming system to unlock symbol display areas associated with one or more of the reels. In an alternative implementation, the gaming system creates a second set of unlocked symbol display areas (different from the plurality of symbol display areas associated with the plurality of video-based slot machine reels) based in part on the quantity of generated triggering symbols.

For each symbol display area that is unlocked, the gaming system randomly generates and displays at least one symbol from an associated second symbol set. In some implementations, a plurality of symbol display areas share an associated second symbol set. In other implementations, each unlocked symbol display area is associated with its own second symbol set. Each symbol from the second symbol set may be associated with an award or value. In some implementations, the first symbol set and the second symbol set include different symbols. In alternative implementations, the first and second symbol set include the same symbols. In one such implementation, the gaming system randomly generates and displays the at least one symbol for each unlocked symbol display area in a waterfall or cascading format. The gaming system evaluates the generated symbols in the symbol display area to determine an accumulated award based on the symbols generated for the unlocked symbol display areas. The gaming system may also determine if a lock symbol was generated in any of the unlocked symbol display areas. For example, the gaming system may be configured to evaluate the symbol associated with a lowest value award in the second symbol set as a lock symbol. In other implementations, the lock symbol may have no value and can be any suitable symbol. When the gaming system determines that one or more lock symbols were generated in unlocked symbol display areas, the gaming system locks such symbol display areas from receiving additionally generated symbols from the second symbol set for remainder of the game. In some implementations, if any symbol display areas remain unlocked, the gaming system may repeat the above process for the play of the game until all symbol display areas are locked. That is, the gaming system may repeat randomly generating and displaying at least one symbol for each remaining unlocked symbol display area from the second symbol set, evaluate the generated symbols for awards, and lock any relevant unlocked symbol display areas in one or more loops until all symbol display areas are locked.

In alternative implementations, if any symbol display areas remain unlocked, the gaming system may repeat the process a predetermined number of times, such as five times (or some alternative suitable number of times) for the play of the game. In some implementations, if any symbol display areas remain unlocked, the gaming system may repeat the process a predetermined number of times based in part on a player's wager or based on part on a triggering event for the play of the game.

In some implementations, the gaming system initiates the repeating free spin win accumulator based on as few as one triggering symbol. In some implementations, the gaming system is configured to generate the at least one triggering symbol frequently. In some implementations, the amount available for a player to win in the repeating free spin win accumulator game is not predetermined. In some implementations, the gaming system is configured to include only winning values or positive values in the second symbol set. In some implementations, the more a player wagers on a game, the gaming system is configured to increase the quantity of high value symbols that are available for the repeating free spin win accumulator portion of the game.

In some implementations, upon a predetermined triggering event, one or more symbol display areas can be added to a game screen. The triggering event may include the gaming system displaying at least one expansion triggering symbol, which may be the same or different than the triggering symbol that triggers a repeating free spin win accumulator game feature. In an implementation of a gaming system having a number of reels, display of an expansion trigger symbol may add additional symbol display areas to the reel containing to expansion trigger symbol. For example, if the reels of the gaming system each initially included three symbol display areas, the gaming machine may add a fourth symbol display position to a first reel in response to the first reel displaying the expansion trigger symbol in one of its three original symbol display areas.

In some implementations, a number of symbols display positions added corresponds to a number of expansion trigger symbols displayed. For example, if the first reel of a slot machine game display displays two expansion trigger symbols, then the gaming system may add two symbol display positions to the first reel. Additionally, if a second reel displayed a single expansion trigger symbol, that the second reel may add one symbol display position to the second reel. In some implementations, the gaming system adds symbol display areas in response to expansion trigger symbols displayed in an active (e.g., wagered) pay line. In some implementations, the gaming system uses the additional symbol display areas for the repeating free spin win accumulator game described above. For example, the additional symbol display areas may be displayed as unlocked symbol display areas.

It should therefore be appreciated that a gaming system and method with a repeating free spin win accumulator creates new and very exciting ways for a player to obtain winning symbols with a potential to earn frequent and greater awards. With every play of the repeating free spin win accumulator gaming system resulting in payouts and with frequent entries into the game, such a gaming system can be highly volatile and extremely exciting for players. The new potential to earn greater awards creates a greatly improved sense of anticipation for players.

As described above and set forth in greater detail below, gaming systems in accordance with aspects of the present disclosure provide a specialized computing device integrating non-generic hardware and software that improve upon the existing technology of human-computer interfaces by providing unconventional functions, operations, and symbol sets for generating interactive displays and outputs. The features of the gaming system provide a practical implementation that improves the operation of the gaming systems for their specialized purpose of providing entertainment by reducing player disappointment with game outcomes, by enhancing player enjoyment, and by increasing player engagement.

In some implementations, the features described herein technically improve the operation of gaming systems for their specialized purpose by merging multiple game features (e.g., game features, game stages, or sub-games) into a single game presented on a common game display device so that the overlapping game features operate in cooperation, rather than operating in isolation. For example, gaming systems in accordance with the present disclosure can provide a bonus feature and expansion feature using the same symbol display areas as those used for a base game feature. Merging the multiple game features so they overlap and cooperate in a common game display device technically improves some implementations of the gaming system by reducing the display area used by the gaming system. Thereby, such implementations of the gaming system can reduce power consumption in comparison to gaming systems that use, for example, a display area to display a base game, and a different display area to display a substantially separate bonus feature. Further, doing so can reduce the physical complexity and manufacturing cost of the gaming systems in some implementations by reducing the number or size of game display devices included in the gaming systems.

Additionally, the features of the gaming system technically improve the operation of the gaming systems for their specialized purpose by providing unique combinations of functions that link game features having multiple rounds. Linking two or more game features together allows games initiated by gaming systems in accordance with the present disclosure can be completed more quickly than systems that provide such games separately. By doing so, the disclosed gaming systems can increase the usage rate (e.g., duty cycle) of the gaming system by allowing more games to be completed in a shorter time period (e.g., games per hour or games per minute) and by reducing power consumed during a single play of the game. When such speed and efficiency improvements are applied in the hundreds or thousands of game evaluations performed over time at multiple installations of the gaming system (e.g., multiple devices installed at multiple casinos), implementations of the disclosed gaming system provide gaming operators substantial improvement in gaming system efficiency.

### BRIEF DESCRIPTION OF THE DRAWINGS

FIG. 1 is a perspective view of some implementations of a stand-alone gaming system of a gaming system in accordance with aspects of the present disclosure.

FIG. 2 is a functional block diagram of the gaming system technology components of the gaming system in accordance with aspects of the present disclosure.

FIGS. 3A, 3B, and 3C illustrate some implementations of a method of operating the gaming system including a repeating free spin win accumulator in accordance with aspects of the present disclosure.

FIGS. 4A, 4B, 4C, 4D, 4E, 4F, 4G, 4H, and 4I illustrate screen shots of some implementations of a gaming system comprising a repeating free spin win accumulator in accordance with aspects of the present disclosure.

FIGS. 5A, 5B, 5C, 5D, 5E, 5F, 5G, 5H, 5I, 5J, 5K, and 5L illustrates some implementations of a gaming system comprising a repeating free spin win accumulator in accordance with aspects of the present disclosure.

FIGS. 6A and 6B illustrate some implementations of a gaming system comprising a repeating free spin win accumulator with a cascading or waterfall win in accordance with aspects of the present disclosure.

FIG. 7 illustrates another implementation of a gaming system comprising a repeating free spin win accumulator with an alternative cascading or waterfall win in accordance with aspects of the present disclosure.

FIG. 8 illustrates some implementations of a pay table for a repeating free spin win accumulator in accordance with aspects of the present disclosure.

FIGS. 9A, 9B, 9C, and 9D illustrate an implementation of a method of operating the gaming system in accordance with aspects of the present disclosure.

FIGS. 10A, 10B, 10C, 10D, 10E, 10F, 10G, 10H, and 10I, illustrate screen shots of an implementation of a gaming system in accordance with aspects of the present disclosure.

FIG. 11 illustrates some implementations of a pay table in accordance with aspects of the present disclosure.

### DETAILED DESCRIPTION

Various implementations of a gaming system and method are disclosed as having a repeating free spin win accumulator associated with unlocked symbol display areas. In some implementations, the gaming system accumulates wins in a predetermined format. In some implementations, the predetermined format for accumulated wins is a waterfall or cascading format.

In some implementations including the repeating free spin win accumulator, a gaming system may include a plurality of symbol display areas. Upon a triggering event, one or more of the symbol display areas are set to an unlocked state for a play of a game. In some implementations, the triggering event may include the gaming system generating at least one predetermined triggering symbol. For each symbol display area that is unlocked, the gaming system randomly generates and displays at least one symbol from a set of symbols. Each symbol from the set of symbols may be associated with an award or value. In some implementations, the gaming system randomly generates and displays the at least one symbol for each unlocked symbol display area in a predetermined format. The gaming system may determine if a lock symbol was generated in any of the unlocked symbol display areas. In one such implementation, where the gaming system determines that one or more lock symbols were generated in unlocked symbol display areas, the gaming system locks such symbol display areas from receiving additionally generated symbols from the set of symbols for remainder of the game. The gaming system also evaluates the generated symbols in the symbol display area to determine an accumulated award. In some implementations, if any symbol display areas remain unlocked, the gaming system may repeat the process for the play of the game until all symbol display areas are locked. That is, the gaming system may randomly generate and display at least one symbol for each remaining unlocked symbol display area. In alternative implementations, if any symbol display areas remain unlocked, the gaming system may repeat the process a predetermined number of times, such as five times (or some alternative suitable number of times). In some implementations, if any symbol display areas remain unlocked, the gaming system may repeat the process a predetermined number of times based in part on a player's wager or based in part on a triggering event.

Implementations consistent with the present disclosure provide a gaming system. The gaming system can include one or more processors and one or memory device storing program instructions for a game. The program instructions, when executed by the one or more processors can configure the gaming system to receive a wager for the game using a credit balance established for the gaming system. The gaming system can also initiate a play of the game. The gaming system can also randomly determine symbols for symbol display areas of a game screen. The gaming system can also display, using a game display device, the symbols in the symbol display areas. The gaming system can also determine that the symbols trigger a first feature of the game. The gaming system can also select, in response to the triggering of the first feature, a plurality of the symbol display areas. The gaming system can also randomly determine one or more credit symbols for one or more symbol display areas of the plurality of the symbol display areas. The gaming system can also display, using the game display device, the one or more credit symbols in the one or more symbol display areas of the plurality of the symbol display areas. The gaming system can also determine an award based on the one or more credit symbols. The gaming system can also update the credit balance based on the award. The gaming system can also determine whether to continue the first feature of the game based on the one or more credit symbols. The gaming system can also issue a value based on the credit balance in response to a cash out request.

Implementations consistent with the present disclosure also provide a method of operating a gaming system. The method can include receiving a wager for a game using a credit balance established for the gaming system. The method also includes initiating a play of the game. The method also includes randomly determining symbols for symbol display areas of a game screen. The method also includes displaying, using a game display device, the symbols in the symbol display areas. The method also includes determining that the symbols trigger a first feature of the game. The method also includes selecting, in response to the triggering of the first feature, a plurality of the symbol display areas. The method also includes randomly determining one or more credit symbols for one or more symbol display areas of the plurality of the symbol display areas. The method also includes displaying, using the game display device, the one or more credit symbols in the one or more symbol display areas of the plurality of the symbol display areas. The method also includes determining an award based on the one or more credit symbols. The method also includes updating the credit balance based on the award. The method of includes determining whether to continue the first feature of the game based on the one or more credit symbols. The method also includes issuing a value based on the credit balance in response to a cash out request.

Implementations consistent with the present disclosure also provide a non-transitory computer-readable storage device having program instructions stored thereon. The program instructions being executable by a processor can cause a gaming system to receive a wager for a game using a credit balance established for the gaming system. The game system can also initiate a play of the game. The game system can also randomly determine symbols for symbol display areas of a game screen. The game system can also display, using a game display device, the symbols in the symbol display areas. The game system can also determine that the symbols trigger a first feature of the game. The game system can also select, in response to the triggering of the first feature, a plurality of the symbol display areas. The game system can also randomly determine one or more credit symbols for one or more symbol display areas of the plurality of the symbol display areas. The game system can also display, using the game display device, the one or more credit symbols in the one or more symbol display areas of the plurality of the symbol display areas. The game system can also determine an award based on the one or more credit symbols. The game system can also update the credit balance based on the award. The game system can also determine whether to continue the first feature of the game based on the one or more credit symbols. The game system can also issue a value based on the credit balance in response to a cash out request.

Gaming System Platform

The features and advantages of the gaming system and method described herein may be provided to a player via a gaming system platform that includes various structures and components for allowing player interaction with the gaming system. While only one gaming system platform will be described in detail herein, the features, objects, and advantages of the gaming system described herein may be implemented in one or more alternative gaming system platforms.

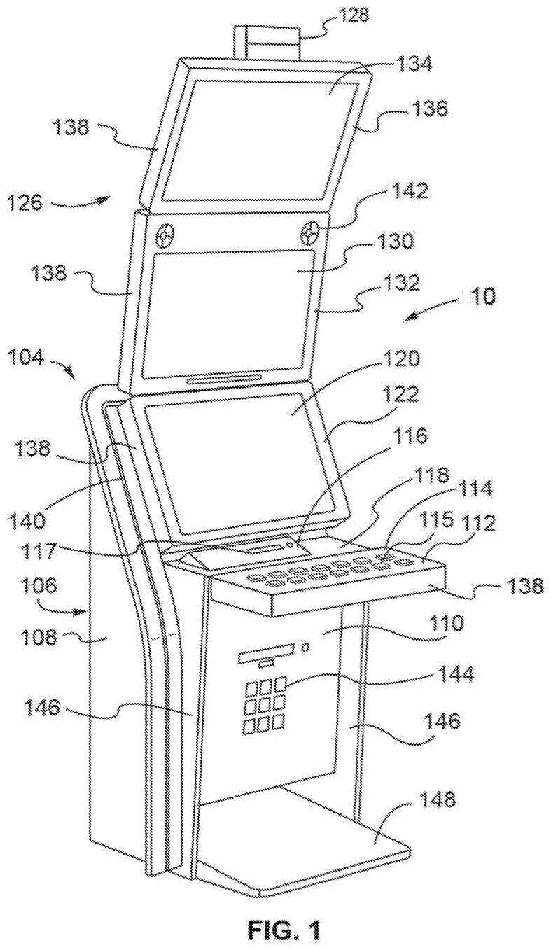

Some implementations of a gaming system platform is shown in FIG. 1 where a gaming system 10 is generally shown. In some implementations, the gaming system 10 is referred to as a slot machine and is illustrated as housed in a housing or cabinet constructed so that a player can operate and play the gaming system 10 while standing or sitting.

Gaming system 10 may include cabinet 105 for housing the components fully described hereinbelow. The cabinet 105 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display device 120 and the player interaction area 112, are provided. The cabinet panels are interconnected along their edges and cooperate to form a cabinet enclosure for housing the gaming system, as can be seen in FIG. 1.

It should be appreciated that a wide variety of cabinet enclosure sizes, shapes, and designs are possible for the gaming system 10. Cabinet 105 may function to securely protect any local control system, technology components, and provide support for game display device(s) and player input and output interactions with the gaming system.

Returning to FIG. 1, the gaming system enables the player to interact with the gaming system 10 to direct the wagering and game play activities and preferences. Various forms of player interaction devices and activities will now be described.

Cabinet 105 includes a player interaction area having input and output areas generally designated as 112. The player interaction area 112 may be located on the front top side of cabinet 105 and, as shown, on a panel structure that extends outwardly from the gaming system in a player's direction. Player interaction area 112 may contain a plurality of player input and output structures such as player control button area 114, player value acceptor and dispenser area 116, and player convenience input area 118.

Player control button area 114 includes a plurality of player input devices 115, such as buttons, touch sensitive areas, or both through with which players may interact with the one or more processors of gaming system 10 and direct game play. It is expected that cabinet 105 provides an easily accessible location and support for all necessary player input/output (I/O) interactions with the device, including gaming control interactions and value wagering interactions. Although the gaming system 10 illustrated in FIG. 1 shows player controls provided by buttons of player control button area 114, it is understood that in some implementations, a player's gaming control interactions could be made by either buttons mounted on cabinet 105 or “soft” buttons located on the gaming display and activated by player touch (e.g., touch screen interfaces), or a combination of both arrangements.

Player control button area 114 may include, for example: game selection button(s) in any implementations where more than one game is provided in a single gaming system; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming system credits; an attendant call button; and gaming system information buttons such as show pay tables, show game rules, or show other game-related information. As discussed above, the functions of the buttons in player control button area 114 may be duplicated with soft buttons in the player control button area 114 or as soft buttons in other areas of the gaming system 10 (e.g., as a touch screen overlay over available game display devices).

Gaming system 10 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming system 10 via one or more value acceptor devices. In some implementations, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming system 10 accepts coins and bill, the gaming system 10 includes a currency bill validator and a coin validator as the value acceptor devices. Likewise, if the gaming system 10 accepts tickets, the gaming system includes a ticket acceptor as a value acceptor device for receiving tickets or vouchers representing some monetary value. The ticket acceptor may include a bar code reader, or other appropriate code reader, for reading the encoded value contained by the player's ticket or voucher. In some implementations, the player value acceptor and dispenser area 116 may include a value acceptor device that can accept more than one type of value. In some implementations, the player value acceptor and dispenser area 116 may include multiple different value acceptor devices to accept different types of value from players

Upon receipt of some type of value from the player, a value acceptor device of the player value acceptor and dispenser area 116 performs validation on the player supplied value using appropriate hardware readers (e.g., determining that the currency bills/coins/tokens are genuine or the ticket/voucher is genuine). If the validation result is positive on player supplied value, the appropriate value acceptor device generates a signal to a processor of the gaming system 10 to establish a gaming credit balance for plays of one or more games on gaming system 10.

In some implementations, a player receives monetary value, or a representation thereof, from the gaming system 10 when a player chooses to “cash out” the gaming credit balance (e.g., remove value from the gaming system 10). The player can cash out at any suitable time. When a player cashes out the value contained on a credit meter (not shown) of gaming system 10, a processor of gaming system 10 may cause a printer of gaming system 10 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming system, or converted to currency at a conveniently located kiosk or cashier counter located near the gaming system. Alternatively, the processor of gaming system 10 may cause a currency bill dispenser or a coin dispenser in gaming system 10 to dispense the value contained on the credit meter of gaming system 10.

Various combinations of the above value acceptance and value distribution arrangements are possible. Gaming system 10 may include other value acceptance and value distribution mechanisms in the player value acceptor and dispenser area 116. For example, gaming system 10 may include a magnetic strip or chip card reader/writer in order to accept value from and transfer value to a magnetic strip or an embedded chip card. In other implementations, hardware for transferring (and receiving) non-traditional currencies to players such as digital currencies (e.g., bitcoin) may be included in gaming system 10.

In an alternative implementation, gaming system 10 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system may be associated with the player account. It is noted that a numeric or alphanumeric keypad may be provided adjacent to the card reader slot to enable player entry of a personal identification number or the like for secure access to card information.

In some implementations, a player convenience input area 118 may be included in the gaming system 10, as is shown in FIG. 1. In various implementations, player convenience input area 118 may have a variety of features and functions depending on the jurisdictional deployment of the gaming system 10. In some implementations, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming system during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. Gaming system 10 may include one or more universal serial bus (USB) ports that enables a player to charge their electronics or connect to services such as the Internet or food service. Further, player convenience input area 118 of gaming system 10 may include buttons to request food or drink service if the gaming system is located in an establishment that has food and drink service. The gaming system 10 may be connected to a local or wide area network such that selection of the requested food or drink service will alert the establishment's hospitality staff to deliver the requested service directly to the gaming system 10.

The layout of the player control button area 114, player value acceptor and dispenser area 116 and the player convenience input area 118 in gaming system 10 may be arranged differently than those disclosed and illustrated herein. The selections and arrangement of input locations on the cabinet 105 may be dependent upon the game buttons, the type of value wagered, and the player conveniences utilized in the deployment configuration of gaming system 10.

With continuing reference to FIG. 1, in some implementations, lower cabinet body portion 106 includes a first game display device 120 mounted atop or flush with the lower cabinet body portion's top panel surface. First game display device 120 is, for example, a 27-inch liquid crystal display (LCD) display mounted in a widescreen orientation. However, any suitable display may be used in any suitable orientation. In the illustrated implementation, the first game display device 120 is mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 will be described below. In some implementations, gaming system 10 may use one first game display device 120 and not include additional game display devices (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game display devices.

At the topmost end of the support structure, a cabinet top light 128 may be provided. The cabinet top light 128 is capable of illumination in a variety of colors and is utilized to indicate and communicate gaming system conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 10 includes two additional displays, second game display device 130 and third game display device 134. Second game display device 130 and third game display device 134 are disposed generally in a vertical relationship and generally in alignment with the first game display device 120. Like the first game display device 120, second game display device 130 and third game display device 134 can be 27-inch LCD displays and can be mounted in a widescreen orientation in some implementations. However, any suitable display in any suitable orientation may be used for the second game display device 130 and the third game display device 134. Further, like the first game display device 120, second game display device 130 and third game display device 134 can be mounted within and framed by second display frame 132 and third display frame 136, respectively. Second display frame 132 and third display frame 136 are attached to the upper cabinet support structure and can protect the second game display device 130 and the third game display device 134.

First game display device 120, second game display device 130, and third game display device 134 can be disposed at an angle from each other to form a player-facing concave arc. However, in some implementations, the angles between the displays may be adjustable and may be smaller or greater than the angles illustrated in FIG. 1. Further, it is understood that in some implementations the displays may be disposed in a common plane relative to each other.

It also should be appreciated that in various implementations a variety of display technology may be utilized equivalently and interchangeably with a variety of implementations of the gaming system. Equivalent display devices include all variations of liquid crystal displays, light emitting diode displays, and plasma displays.

In some implementations, different sized displays may be combined to display gaming data on gaming system 10. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 10 may communicate with the disclosed first game display device 120, second game display device 130, and third game display device 134 through a video card of gaming system 10 to produce the visible aspects of a game.

In some implementations, one or more of the first game display device 120, second game display device 130, and third game display device 134 may be fitted with a transparent touch sensitive overlay for sensing player touch inputs into the gaming system. Touch sensitive overlays can communicate with a processor of gaming system 10 to enable the player to interact with the game.

In some implementations, the curved displays may be used for any or all of the first game display device 120, second game display device 130, or third game display device 134. Similarly, any of the displays used for gaming system 10 can be based on flexible display technologies. For example, it is possible to utilize flexible display technologies to create uniquely shaped curving, wavy, or tubular display structures to provide one or more of the first game display device 120, second game display device 130, and third game display device 134. Additionally, in some implementations flexible display technologies can be used in combination with fixed flat screen technologies.

While the gaming system 10 has been described as implemented with video technologies, in some implementations, mechanical reels with reel strips containing game indicia and step motor controllers may be employed to provide game information to a player. In some implementations, the reel strips may include a plurality of printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming system housing style, a variety of other display technologies may be utilized in combination with the gaming system disclosed herein. For example, in some implementations a gaming system may have one or more game display devices in addition to the main game display device(s). For example, the gaming system may include a player tracking device having a player tracking display which displays various information to the player regarding the player's status. The gaming system may also include other game-related displays such as the wager display and the gaming credit balance display. These additional game-related displays may be separate game display devices or may be displayed on any one or more of the first game display device 120, the second game display device 130, or the third game display device 134.

Cabinet lighting design functions to attract players to a gaming system 10. In the implementation of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming system 10 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming system displays frames, as well as the player interaction area, to highlight these areas.

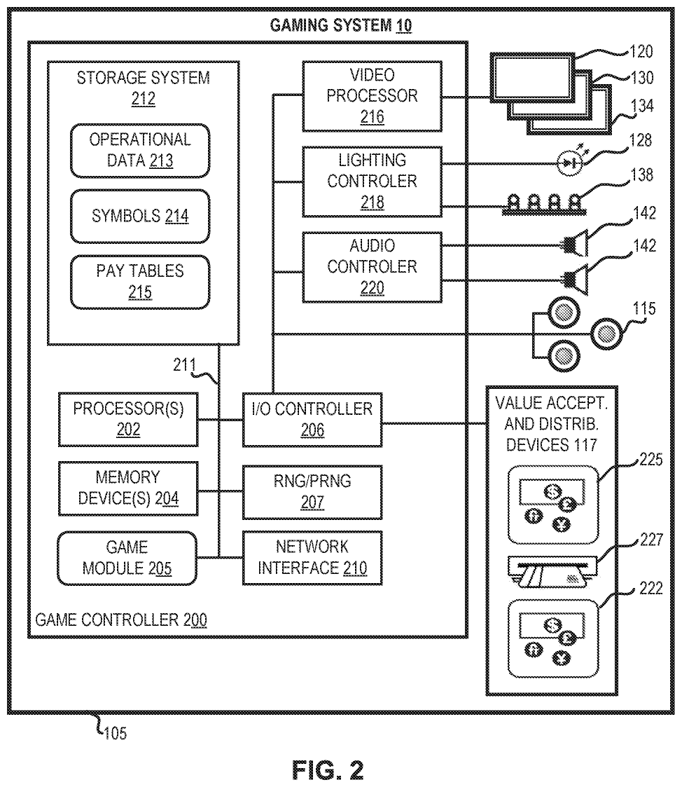

In some implementations, the individual LEDs mounted on the LED strips are of a type that can emit red, green, and blue light. In an alternative implementation, separate LEDs are used for each required light color. All LED strips can be electrically connected and can be controlled by a cabinet lighting controller 218 (illustrated in FIG. 2) in conjunction with a processor of gaming system 10 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some implementations, cabinet 105 may include LED strip lighting or LED rope lighting to accentuate the cabinet and enhance the attractiveness of gaming system 10 to players. LED rope lighting is a plurality of small light-emitting diode bulbs linked together and encased in a plastic, polyvinylchloride, or other suitable material to create a string of lights. For example, in the implementation of FIG. 1, cabinet 105 includes cabinet accent lighting 140. In some implementations, cabinet accent lighting 140 is LED rope lighting mounted flush with the front side edge of the cabinet side panels 108. The LED rope lighting can generate any of suitable colors, and are controlled by cabinet lighting controller 218 and a processor of gaming system 10 to selectively mix the emitted light colors in a manner to create any color in the same manner as the frame edge lighting.

In various implementations, gaming system 10 includes one or more audio speakers and appropriate driving electronics and sound cards so that game players may experience pleasing audio aspects of the gaming system 10. Audio is desirable to attract and maintain player interest in gaming system 10. Gaming system 10 may also emit attraction sounds during any idle period of gaming system 10. Game audio may add to the player's enjoyment of gaming system 10 by providing music and sound effects designed to enhance and compliment the gaming experience.

Audio speaker hardware may include one or more speakers disposed in or on the cabinet 105 of gaming system 10. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some implementations. Speaker placement may be selected to enhance the sound emitting characteristics of the gaming system. For example, bass speakers or additional speakers 144 may be mounted inside lower cabinet body portion 106. Further, it is envisioned that in some implementations sound processing such as multichannel processing and surround sound processing are included in gaming system 10. Audio jacks for attachment of player headphones may also be provided in some implementations of gaming system 10 for the player to further enhance the audio experience of the game and also to block out noise from other gaming systems.

In some implementations, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming system 10 in a seated position. Foot rest 148, which may be cushioned, is provided below player interaction area 112 to enhance a player's ergonomic comfort while playing gaming system 10. In some implementations, the edges of player interaction area 112 may be ergonomically cushioned as well.

Gaming system 10 may be embodied in alternative gaming system housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 105 which can comprise a variety of shapes, sizes, and forms. The cabinet 105 can (1) protect and house the operational electronics, (2) adequately support the display(s) in a position easily viewable for a seated or standing player, as necessary (3) provide an easy location and support for all necessary player input/output (I/O) interactions, including gaming control interactions and value wagering interactions. For example, in some implementations the gaming system 10 may be disposed in a housing style referred to as a “slant top” gaming system that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 105 of gaming system 10 may include bar top or table top housing arrangements. These housings are generally small enough to be placed on top of an existing bar or table while providing the requisite gaming system housing functions of protection of/access to gaming electronics, displays, and player I/O functions described above.

In some implementations, cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming system 10. symbolsymbolsymbolsymbol

FIG. 2 shows a functional block diagram illustrating an example of a game controller 200 of a gaming system 10 in accordance with aspects of the present disclosure. The gaming system 10 can include a cabinet 105, one or more player input devices 115, one or more value acceptance and distribution devices 117, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., operational data 213, symbols 214, and pay tables 215) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the memory device 204 may comprise any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 10 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 10 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 10, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 10 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 10. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 10 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 10.

In some implementations, a card reader 227 may be included in gaming system 10 to accept player loyalty cards. For example, the card reader 227 can extract account identifying information from the card and utilizes this information to access the associated account information stored remotely via the network interface 210. In implementations where player loyalty/player tracking systems are used with the gaming system 10, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 10.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 10 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions. In some implementations, the mechanical game reels can be set into a spinning/rotation motion by pulling a lever or pushing a button of the gaming system 10. In some implementations, the gaming system 10 can stop the game reels by allowing the mechanical game reels to stop naturally, or actuating a suitable mechanical or electro-mechanical reel brake on a random timing basis. When the mechanical game reels stop rotating, the gaming system 10 may, using suitable detection mechanisms, determine one or more displayed stop positions of the mechanical game reels. Since the displayed stop positions of the mechanical game reels can be associated with respective indicia or symbols, the gaming system 10 can determine what combination of indicia or symbols are displayed at the stop positions. The gaming system 10 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate random numbers or pseudo-random numbers for determining the displayed stop positions of the mechanical reels. The gaming system 10 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 10 during game execution. In some implementations, the gaming system 10 can utilize the random numbers for the random selection of one or more symbols (e.g., stop positions) along mechanical game reels.

In some implementations, the gaming system 10 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, character, animations, blank symbols (e.g., the absence of symbols), or any other suitable graphical depiction. The gaming system 10 may include one or more video-based reels for a game. The gaming system 10 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, some games on gaming system 10 may not use video-based reels or reel strips, but use random number determinations for game outcomes.

Returning to random number generation, symbols in the reel strips or sets of symbols can be associated with numbers for video-based reels similar to mechanical game reels. In some implementations, when the RNG 207 selects a number, a processor in conjunction with the memory devices 204 of the gaming system 10 can correlate the selected number to an associated symbol to determine what symbol has been randomly selected. In various implementations, once symbols are randomly selected based upon the random numbers generated by the RNG 207, the processor 202 can evaluate the displayed patterns of symbols or randomly determined numbers to determine one or more game outcomes. It should be appreciated that in some implementations, gaming system 10 may include a hardware based random number generator that is in communication with processor 202 to supply random numbers for random symbol determination purposes. The hardware based random number generator may be incorporated into the processor 202 or can be separate from the processor 202.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing sets of symbols.

It should be appreciated that in certain other implementations where gaming system 10 includes physical mechanical game reels to display symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 10.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 10.

In some implementations, the game controller 200 may communicate with one or more devices outside the gaming system 10. For example, gaming system 10 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 10. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 10 from tampering or alteration attempts.

Gaming System Operation

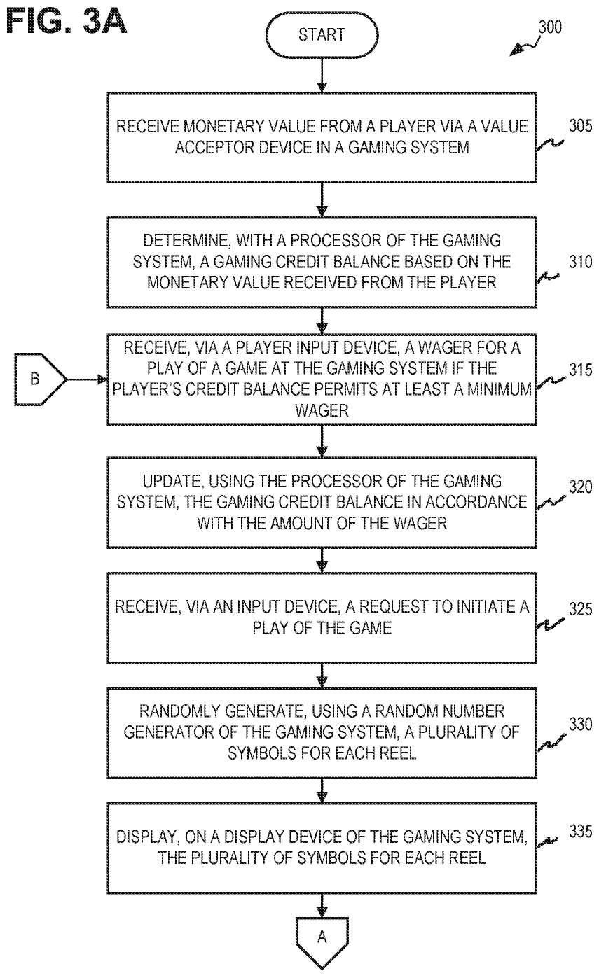

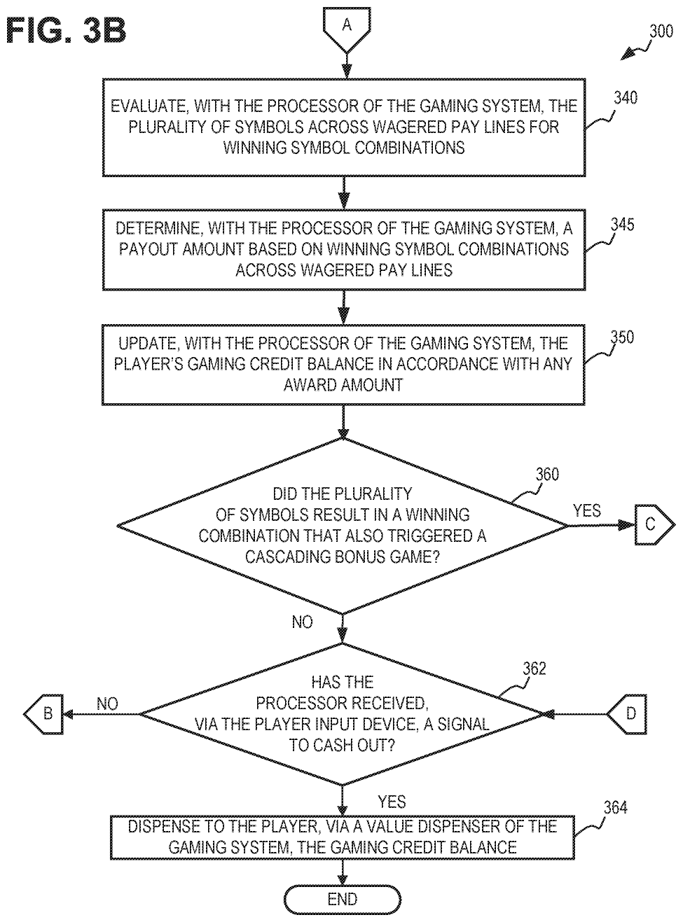

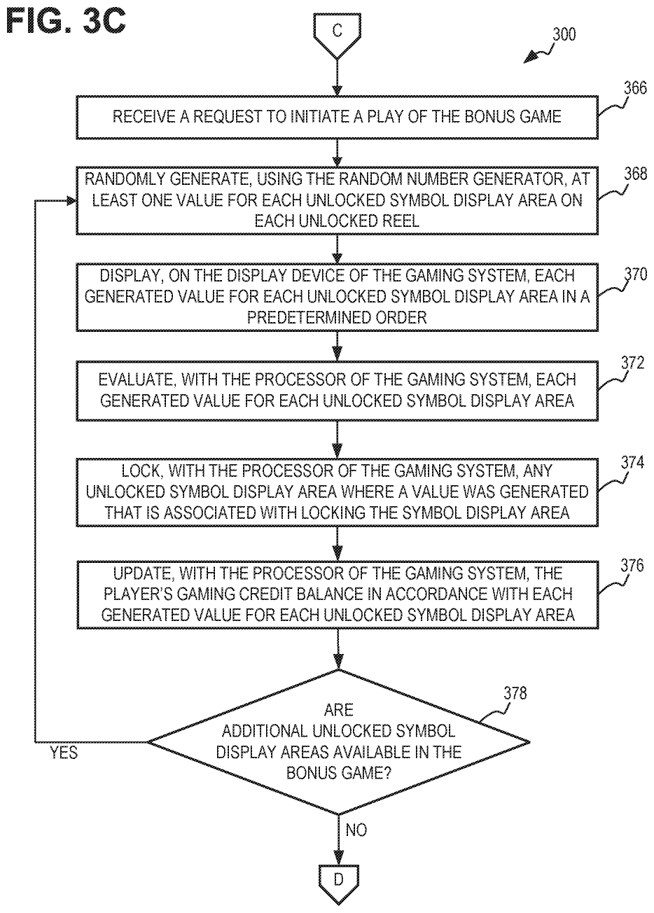

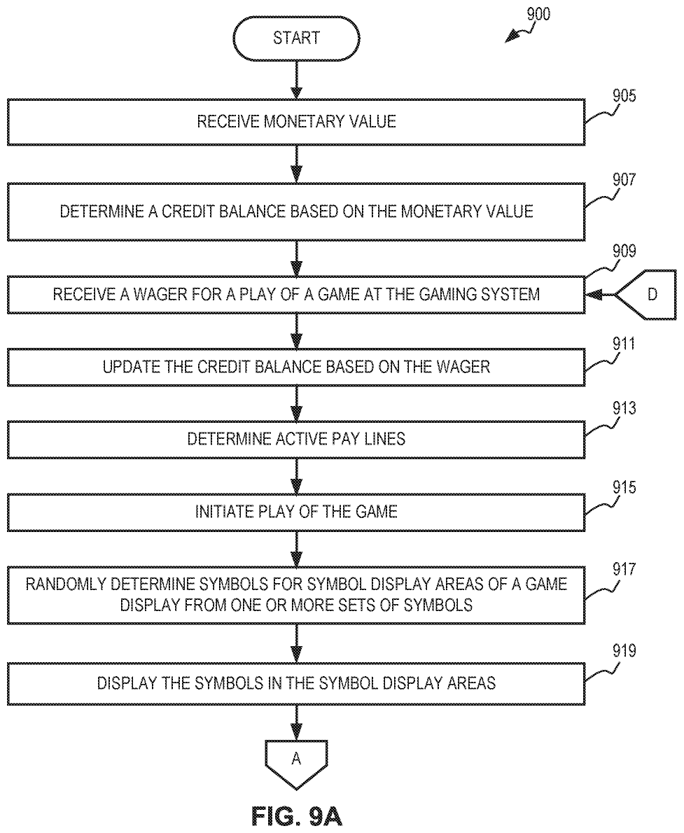

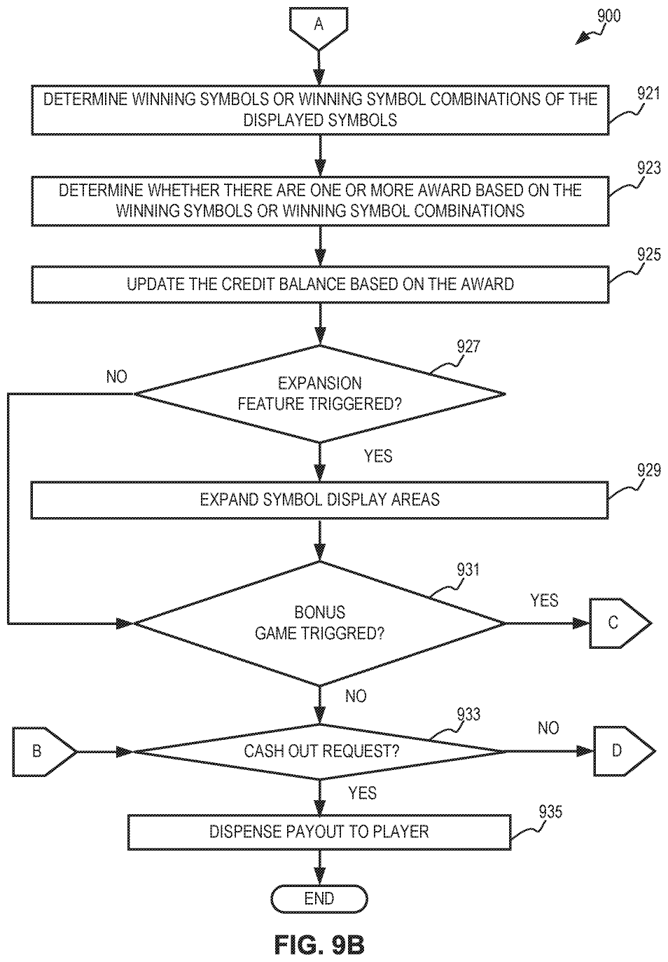

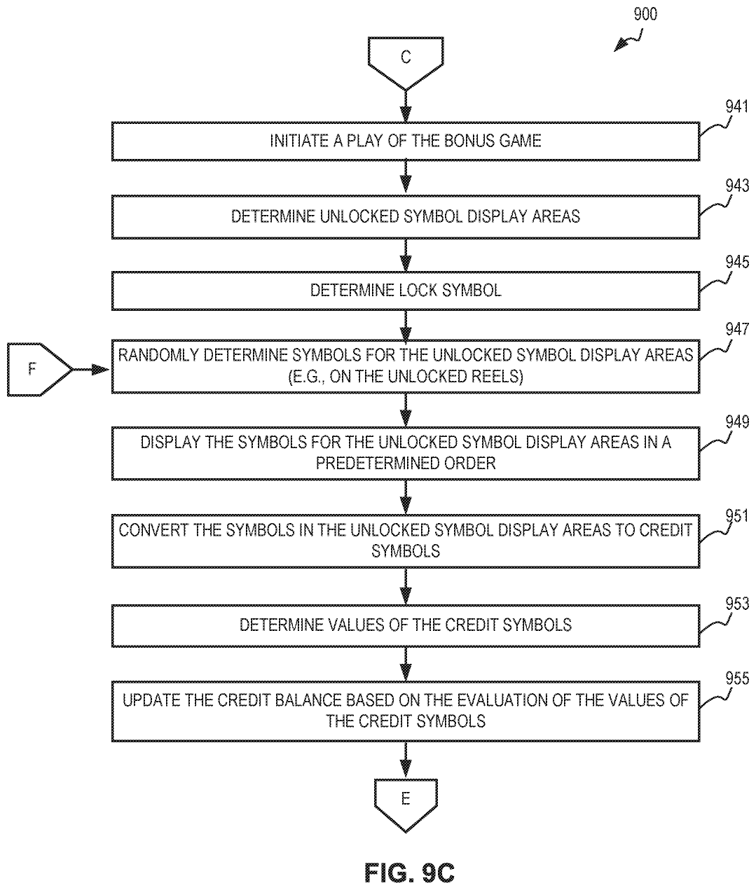

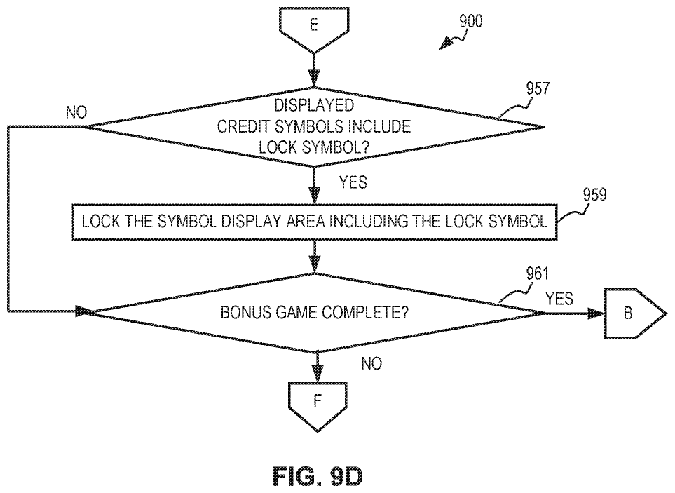

The flow diagrams in FIGS. 3A-3C and 9A-9D illustrate functionality and operations of systems, devices, processes, and computer program products according to various implementations of the present disclosure. Each block in FIGS. 3A-3C and 9A-9D can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 3A-3C and 9A-9D. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions.

FIGS. 3A, 3B, and 3C illustrate a flowchart of an example operation 300 of some implementations of the gaming system and method. FIGS. 3A and 3B are depicted as a base or primary game while FIG. 3C is depicted as a bonus game. However, it should be appreciated that FIG. 3C may be integrated as part of a base game without entering a separate bonus game.

In some implementations, a processor of the gaming system is configured, via instructions stored in a memory device, to perform the operation 300. However, it should be appreciated that other suitable variations of operation 300 are possible. For example, in some implementations, fewer or one or more additional blocks (not shown) may be employed in operation 300 of the gaming system and method. In other implementations, the blocks may be performed in any suitable order.

FIG. 3A illustrates some implementations in which the gaming system receives a monetary value from a player to initiate operation 300. As indicated in block 305, the gaming system may receive monetary value via a value acceptor device associated with the gaming system. The value acceptor device, in some implementations, is disposed in a gaming system or in communication with the gaming system as discussed above.

In some implementations, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In some implementations, the gaming system may receive a wager for a play of a game at the gaming system. Block 315 of FIG. 3A illustrates some implementations where the player's wager is received via a player input device. The gaming system may allow a player to place a minimum wager, a maximum wager, or any suitable wager amount. Depending on the wager amount, the gaming system may also enable the player to select pay lines across displayed symbol positions on reels in a game in which to place wagers. Although in some implementations, the gaming system selects the wagered pay lines automatically based on the player's wager. Wagered pay lines may be referred to herein as active pay lines. In some implementations, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In some implementations, the gaming system may use a processor of the gaming system to update a gaming credit balance. The credit balance may be updated in accordance with the player's wager amount as indicated in block 320. Some implementations, the credit balance is not updated until a later time.

Block 325 illustrates some implementations in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In some implementations, the gaming system may use a random number generator to randomly generate a plurality of symbols from a set of symbols as indicated in block 330. In some implementations, at least some of the symbols in the set of symbols are classified or associated with a symbol type. In some implementations, the gaming system may generate the plurality of symbols for display on a set of reels (or virtual reels). As used herein, the random number generation may refer to pseudo-random or true-random number generation depending on the module used for the random number generation.

In some implementations, the gaming system may cause a game display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in some implementations as shown in block 340, the gaming system evaluates the generated plurality of symbols across active or wagered pay lines for winning symbol combinations. In some implementations, the gaming system evaluates the winning symbol combinations based on the pay lines wagered upon by a player. The gaming system may evaluate the player selected pay lines, gaming system assigned pay lines, or pay lines assigned as active in some other manner for the play of the game. In some implementations using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3C can be rearranged in any suitable order. As such, it should be appreciated that the gaming system may update player's gaming credit balance at other suitable times.

In some implementations, as indicated in block 360, if the gaming system determined that the generated plurality of symbols did not result in triggering a bonus game, operation 300 moves to block 362.

In some implementations, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in some implementations, the wager may not be accepted if the player has fewer credits than the player's selected wager amount as shown in block 315.

Returning now to block 360, if the gaming system determined that the generated plurality of symbols resulted in trigging a bonus game, operation 300 moves to block 366 in FIG. 3C via off page connector C. In some implementations, if the gaming system determines that the generated plurality of symbols includes one or more generated predetermined symbols, the gaming system will trigger or activate the bonus game. In some implementations, the predetermined symbol is a symbol that serves one function: to trigger the bonus game. In alternative implementations, the predetermined symbol serves a plurality of game functions, such as triggering the bonus game and providing an award value. Other suitable game functions may be associated with the predetermined symbol.

In some implementations, generating different quantities of the predetermined symbol cause the gaming system to trigger different bonus games. For example, in some implementations, if the gaming system generated one predetermined symbol, the gaming system may activate a bonus game with one or more unlocked symbol display areas. An unlocked symbol display area is a symbol display area that the gaming system can use to associate and display at least one generated symbol from the bonus symbol set. A locked symbol display area is a symbol display area that the gaming system cannot associate or display any additional generated symbols from the bonus symbol set. In some implementations, if the gaming system generated one predetermined symbol, the gaming system may activate a bonus game with one unlocked reel (or three unlocked symbol display areas). In another implementation, if the gaming system generated one predetermined symbol, the gaming system may activate a bonus game with two unlocked reels (or six unlocked symbol display areas). In some implementations, when the gaming system generates more predetermined symbols, the gaming system will accordingly unlock more reels (or unlock more symbol display areas). It should be appreciated that the ratio of generated predetermined symbols to unlocked symbol display areas or unlocked reels can be set to any suitable ratio. It should also be appreciated that in some implementations, events other than generating one or more of a predetermined symbols may trigger the bonus game.

In some implementations, the gaming system may generate one predetermined symbol on average, 1 in 45 spins. In some implementations, the gaming system may generate two predetermined symbols on average, 1 in 90 spins. In some implementations, the gaming system may generate three predetermined symbols on average, 1 in 120 spins. However, it should be appreciated that any suitable ratios can be used.

Block 366 of FIG. 3C illustrates some implementations in which the gaming system may receive a request to initiate a play of the bonus game. As noted above, the features discussed in connection FIG. 3C may also be applied to primary games or games that are not bonus games. The request to initiate the play of the bonus game may be received from a player via a player input device in communication with the gaming system. For example, the player may press a spin button on the gaming system to start randomly generating symbols for the play of the bonus game. In an alternative implementation, the processor of the gaming system may automatically initiate the play of the bonus game and randomly generate symbols for the play of the game.

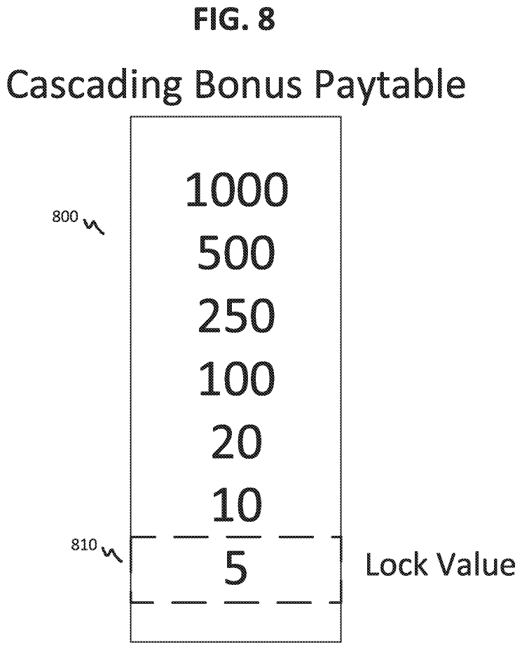

In some implementations, the gaming system uses a random number generator to randomly generate a plurality of symbols from one or more bonus symbol sets for the bonus game as indicated in block 368. For implementations without a bonus game, the gaming system randomly generates the plurality of symbols from one or more second symbol sets. In some implementations, the bonus symbol set comprises one or more symbols that are different from the symbols from the primary game's symbol set. In some implementations, the bonus symbol set comprises the same symbols from the primary game's symbol set. In some implementations, the bonus symbol set comprises symbols that are each associated with an award value. In some such implementations, the symbols in the bonus symbol set are award values such as illustrated in FIG. 8. In FIG. 8, the listed award values 1000, 500, 250, 100, 20, 10 and 5 in pay table 800 each represent an award in a bonus symbol set that the gaming system can randomly generate for plays of the bonus game. In some implementations, the gaming system generates one symbol from the bonus symbol set for each of the unlocked symbol display areas. In some implementations, each unlocked reel is associated with a bonus symbol set, where each of the bonus symbol sets may be the same or different. In some implementations, each unlocked symbol display area is associated with its own bonus symbol set, where each of the bonus symbols set may be the same or different. In some implementations, each bonus symbol set may be represented by a video slot machine reel. Thus, in some implementations where each unlocked symbol display area is associated with an individual bonus symbol set and each bonus symbol set is a video slot machine reel, the bonus symbol sets may be uni-reels.

As also indicated in block 368, the gaming system may associate each of the generated plurality of symbols from the bonus symbol set with one of the unlocked symbol display areas. In some implementations where the unlocked symbol display areas are associated with one or more unlocked reels, the gaming system may associate each of the generated plurality of symbols from the bonus symbol set with one of the unlocked symbol display areas for each unlocked reel.

The gaming system may cause the game display device to display the plurality of symbols generated from the bonus symbol set as indicated in block 370. The gaming system may display the generated plurality of symbols (from the bonus symbol set) in associated unlocked symbol display areas of each of the unlocked reels of the gaming system. In some implementations, the gaming system displays the generated symbols from the bonus symbol set in associated unlocked symbol display areas in a predetermined order. In some implementations, the gaming system displays the generated symbols in a waterfall or cascading order across the unlocked symbol display areas. For example, the gaming system may sequentially display each of the generated symbols from one side of the game display device to the other in unlocked symbol display areas. However, it should be appreciated that the gaming system may display the generated symbols in the unlocked symbol display areas in any suitable manner.

In some implementations, the gaming system generates and displays the plurality of symbols generated from the bonus symbol set in unlocked symbol display areas sequentially and in a predetermined order. That is, in one such implementation, the gaming system generates and displays one of the plurality of symbols from the bonus symbol set in one of the unlocked symbol display areas before generating and displaying another one of the plurality of symbols from the bonus symbol set for a different one of the unlocked symbol display areas. In other implementations, the gaming system generates and displays the plurality of symbols generated from the bonus symbol set in unlocked symbol display areas non-sequentially and in a random order. In some implementations, the gaming system generates all of the necessary plurality of symbols from the bonus symbol set before displaying one of the generated necessary plurality of symbols. In some implementations, as the gaming system displays each generated symbol, the gaming system keeps the generated symbol displayed as each subsequent generated symbol is revealed on the display. In alternative implementations, the gaming system displays each generated symbol, then obscures the displayed symbols before the next symbol is displayed.

In some implementations as shown in block 372, the gaming system evaluates the generated plurality of symbols from the bonus symbol set associated with unlocked symbol display areas. In some implementations, the generated plurality of symbols from the bonus symbol set are each associated with an award value. In some implementations, the award values are all greater than zero. However, in other implementations, the award values may include zero or other suitable values. In some implementations, the symbols from the bonus symbol set are associated with other types of awards, such as additional generations of random symbols for the symbol display areas, free games, free spins, non-monetary prizes, etc. In some implementations, the gaming system evaluates the generated symbols from the bonus symbol set for winning symbol combinations. That is, the gaming system may evaluate the generated symbols from the bonus symbol set as discussed above in the base or primary game.

Returning to the evaluation of block 372, the gaming system may evaluate the generated symbols against an associated pay table (e.g., where generated symbols do not readily translate into award values). The gaming system's evaluation may also result in calculating the award accumulated based on the generated symbols in the unlocked symbol display areas. In some implementations, the gaming system accumulates or calculates the awards associated with the unlocked symbol display areas as each symbol is revealed. In alternative implementations, the gaming system calculates the awards associated with the unlocked symbol display areas all at once. In some implementations where the gaming system generated each of the plurality of symbols for the unlocked symbol display areas all at once (prior to revealing the generated symbols on the display), the gaming system may calculate the total award prior to displaying the symbols to the player.

In some implementations, the gaming system further evaluates the generated symbols from the bonus symbol set for an associated status as a lock symbol. A lock symbol appearing in an associated symbol display area causes the gaming system to lock the associated symbol display area from receiving additionally generated symbols from the bonus symbol set for the remainder of the game. In some implementations, the lock symbol is designated as the lowest value symbol in the bonus symbol set (e.g., the 5 symbol in FIG. 8). In another implementation, the lock symbol is designated as the highest value symbol in the bonus symbol set (e.g., the 1000 symbol from FIG. 8). However, any suitable symbol from the bonus symbol set can be designated as the lock symbol. Since the lock symbol may be associated with a value, the gaming system may still provide an award to the player associated with the locked symbol display area even if the lock symbol is generated. In some implementations, a symbol designated as a lock symbol does not lock an associated symbol display area until after the gaming system generated a predetermined quantity of symbols from the bonus symbol set for the associated unlocked symbol display area. That is, in some implementations, even if a lock symbol is generated for an unlocked symbol display area, the lock symbol may not lock the symbol display area the first one or more times the lock symbol is generated for that symbol display area.

At block 376, the gaming system may update, with the processor, the player's gaming credit balance in accordance with any obtained award amount from the generated symbols from the bonus symbol set. As noted above, the blocks illustrated in FIGS. 3A-3C can be rearranged in any suitable order. As such, it should be appreciated gaming system may update player's gaming credit balance at other suitable times.

At block 378, the gaming system determines whether additional unlocked symbol display areas remain in the bonus game. If unlocked symbol display areas remain, then the operation 300 may return to block 368 to continue with the play of the game and to generate additional symbols from the bonus symbol set for the unlocked symbol display areas. That is, in some implementations, the gaming system may execute blocks 368, 370, 372, 374, 376, and 378 until no unlocked symbol display areas remain, where executing blocks 368, 370, 372, 374, 376, and 378 once is one cycle. In some implementations, the symbol display areas remain unlocked for a predetermined quantity of cycles. For example, the gaming system may permit five cycles (or some other suitable number) for each initially unlocked symbol display area in the bonus game. In such an implementation with a predetermined quantity of random generations, the lock symbol may not be used. In an alternative implementation, the lock symbol is used after the five random generations. That is, in such an implementation with a predetermined quantity of random generations (or cycles), the lock symbol may not be used during the first five random generations for each originally unlocked symbol display area, but can be used to stop the bonus game after the first five random generation cycles by locking down the unlocked symbol display areas.

It should be appreciated that the player may cash out at any time, even if unlocked symbol display areas remain. In some implementations, the player loses the unlocked symbol display areas in the bonus game by cashing out early (e.g., before all symbol display areas are locked in the bonus game). In other implementations, the player retains the unused and unlocked symbol display areas for application to future bonus games. For example, if the player triggers a bonus game with one unlocked reel but stored an unused and unlocked reel from a prior bonus game, the gaming system may unlock two reels for the bonus game.

If no unlocked symbols remain as determined at block 378 in FIG. 3C, then the operation 300 may proceed via off page connector D and return to block 362 in FIG. 3B. As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in some implementations, the wager may not be accepted if the player has fewer credits than the player's selected wager amount as shown in block 315.

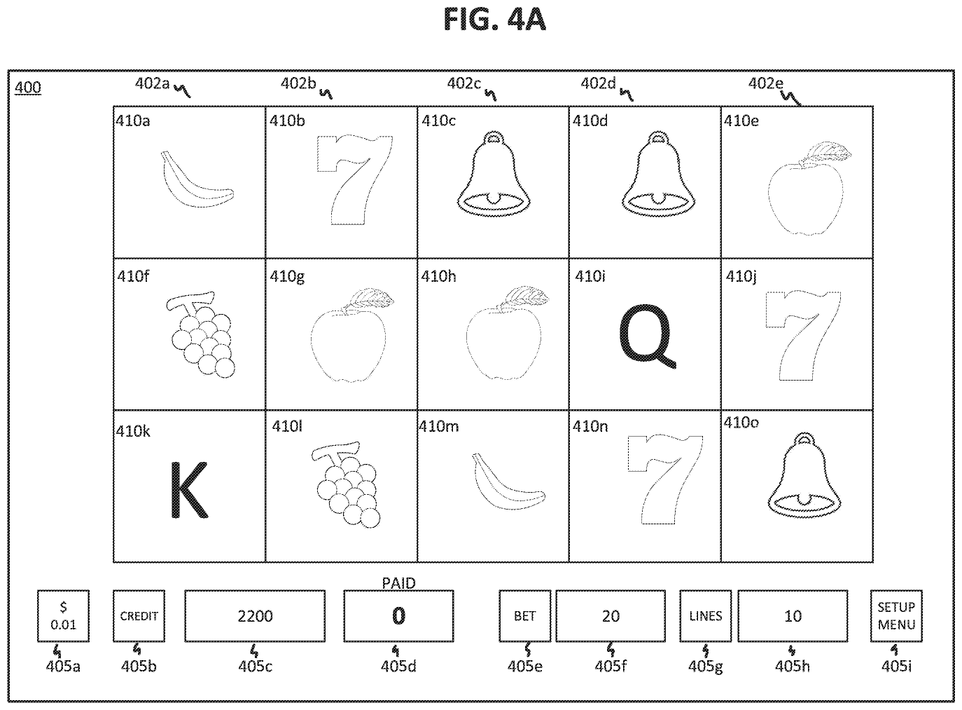

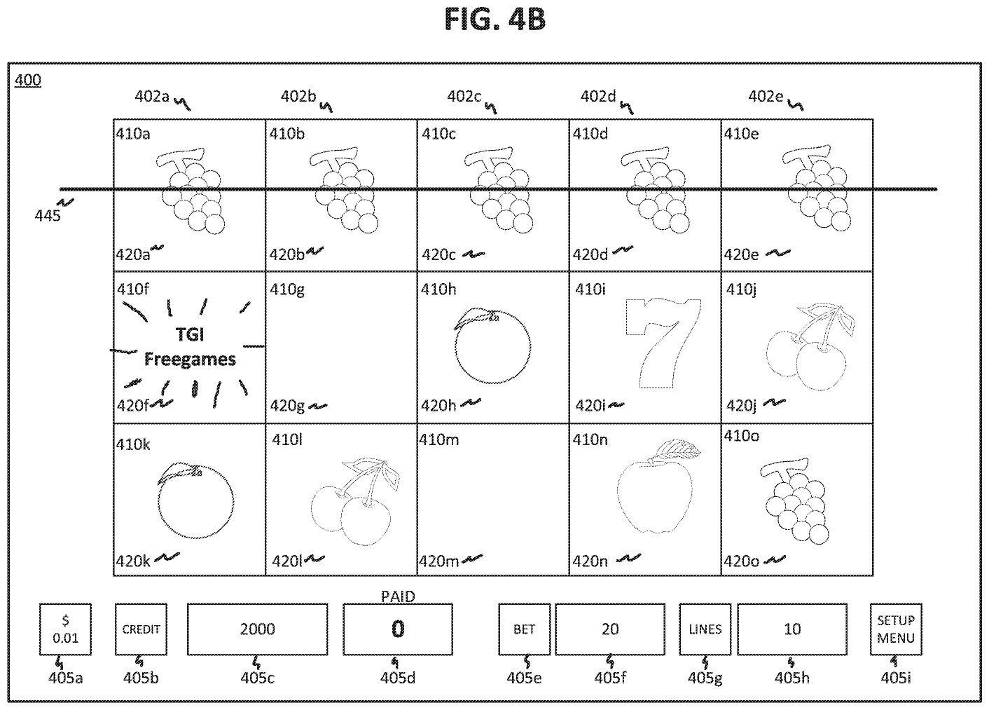

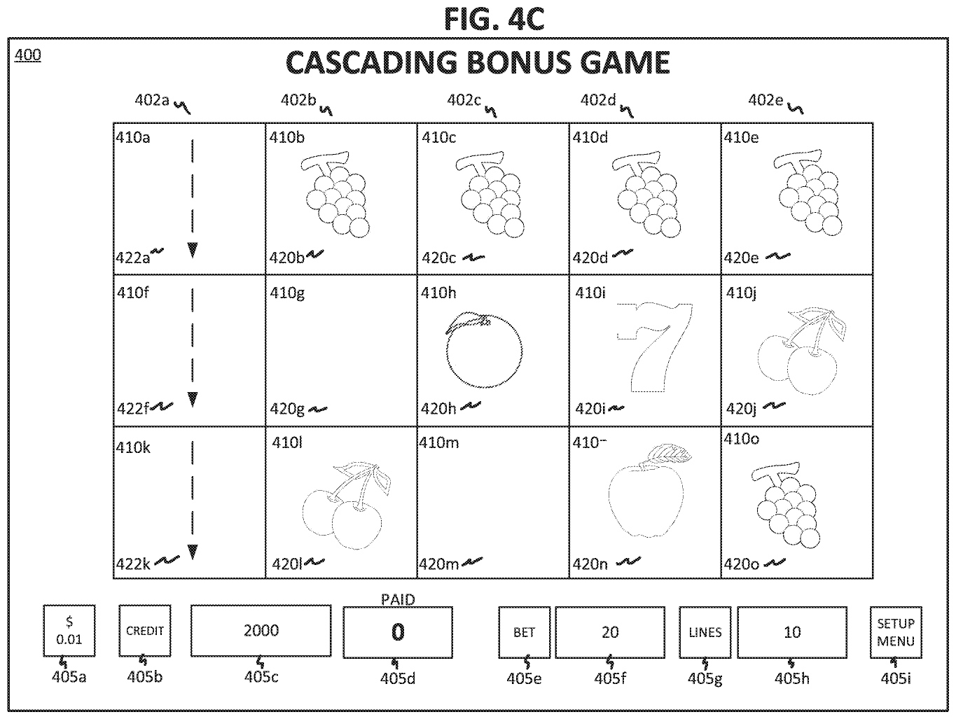

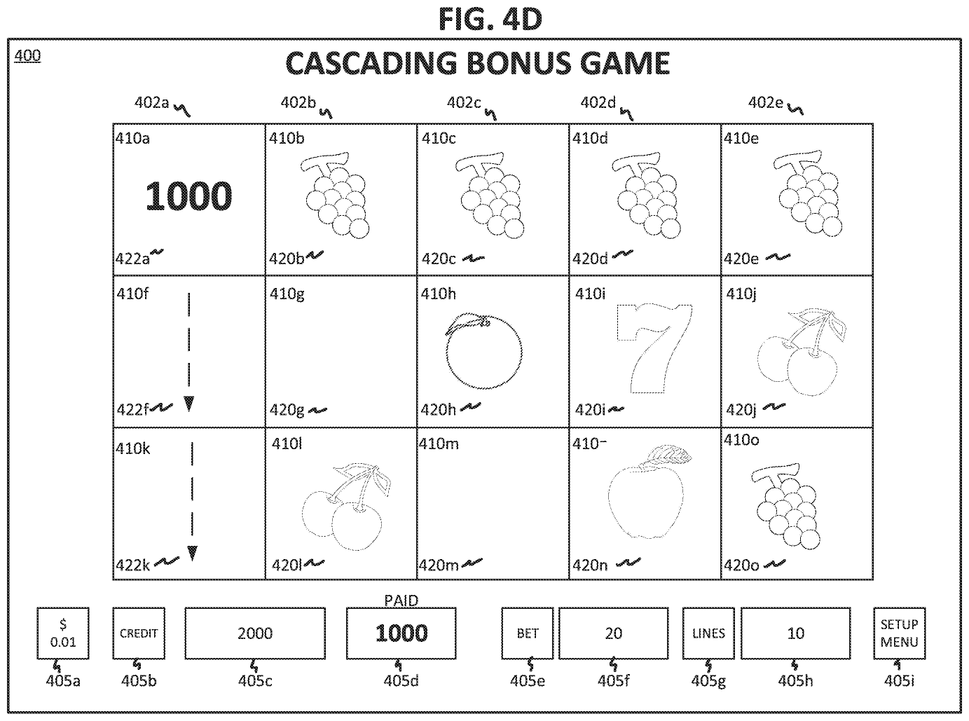

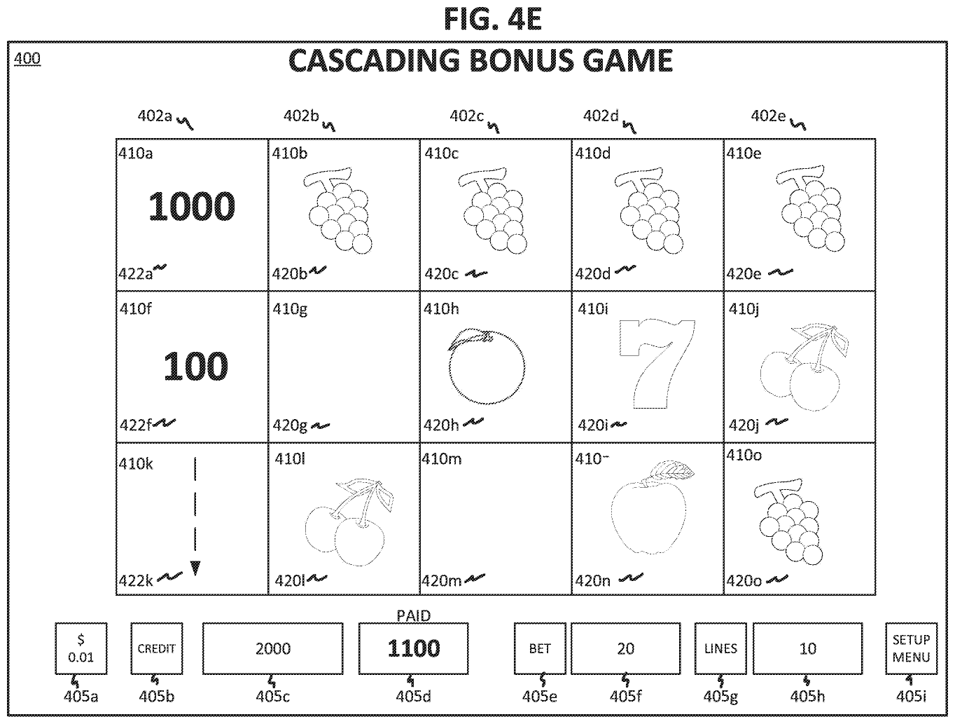

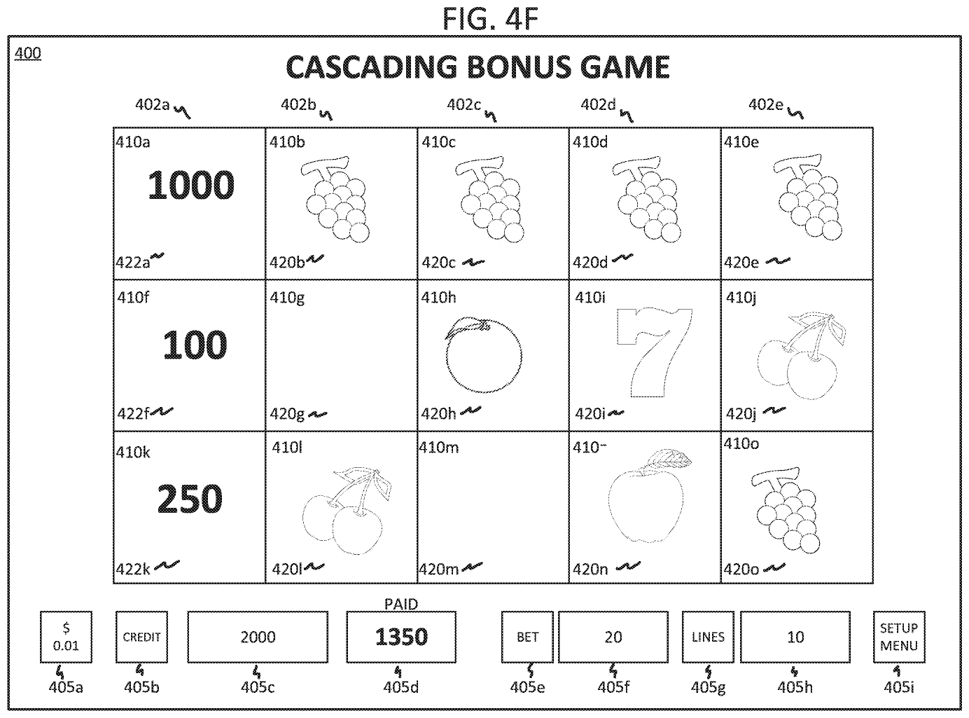

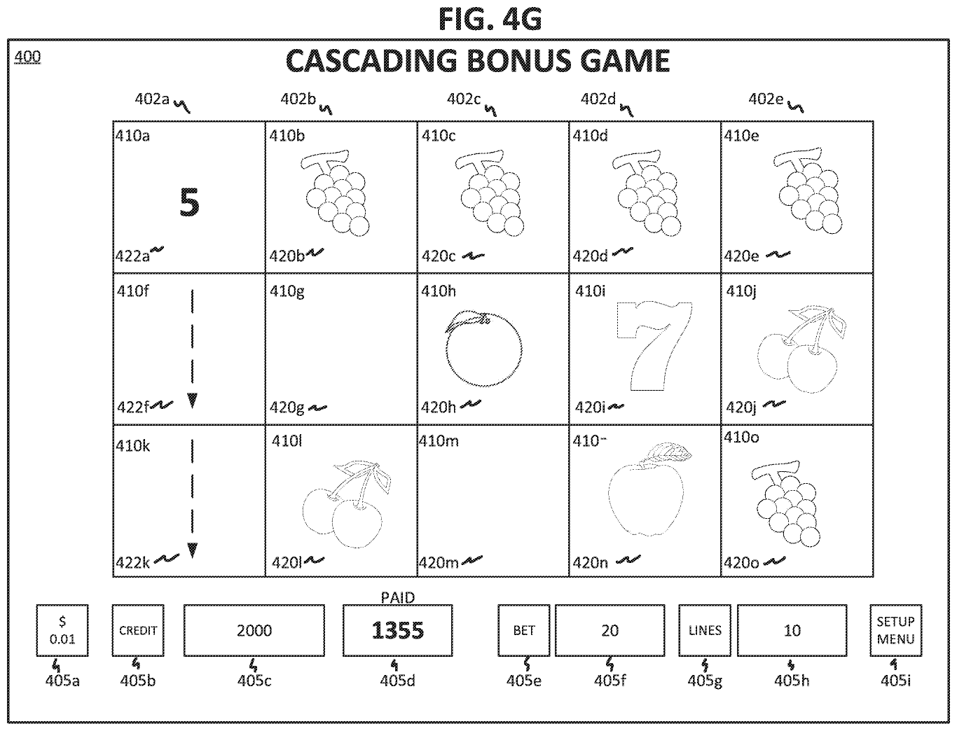

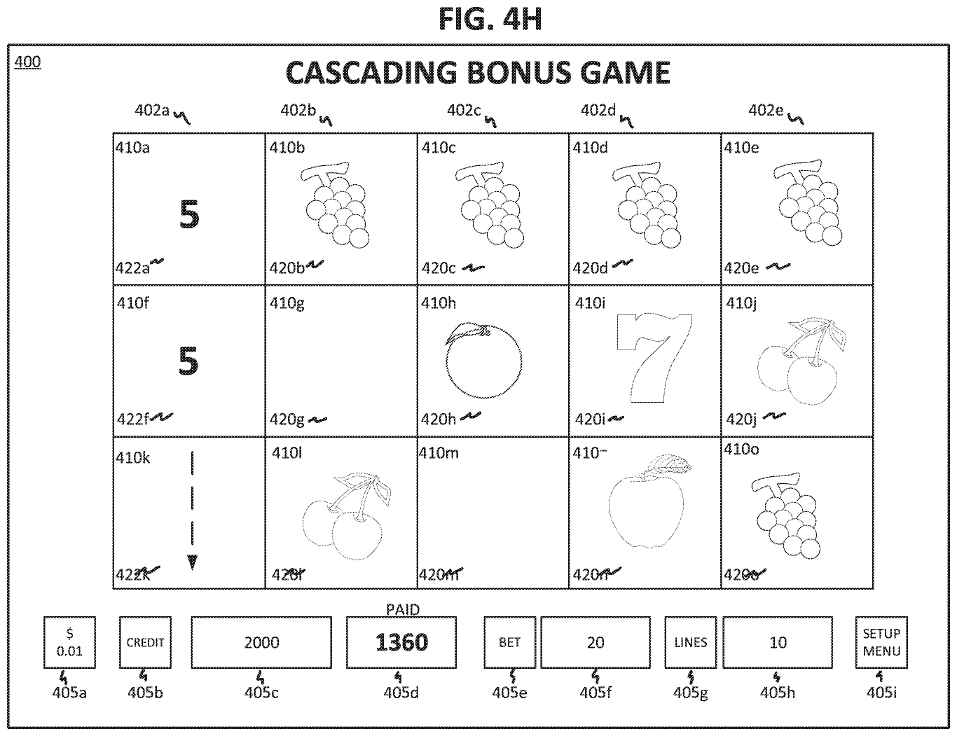

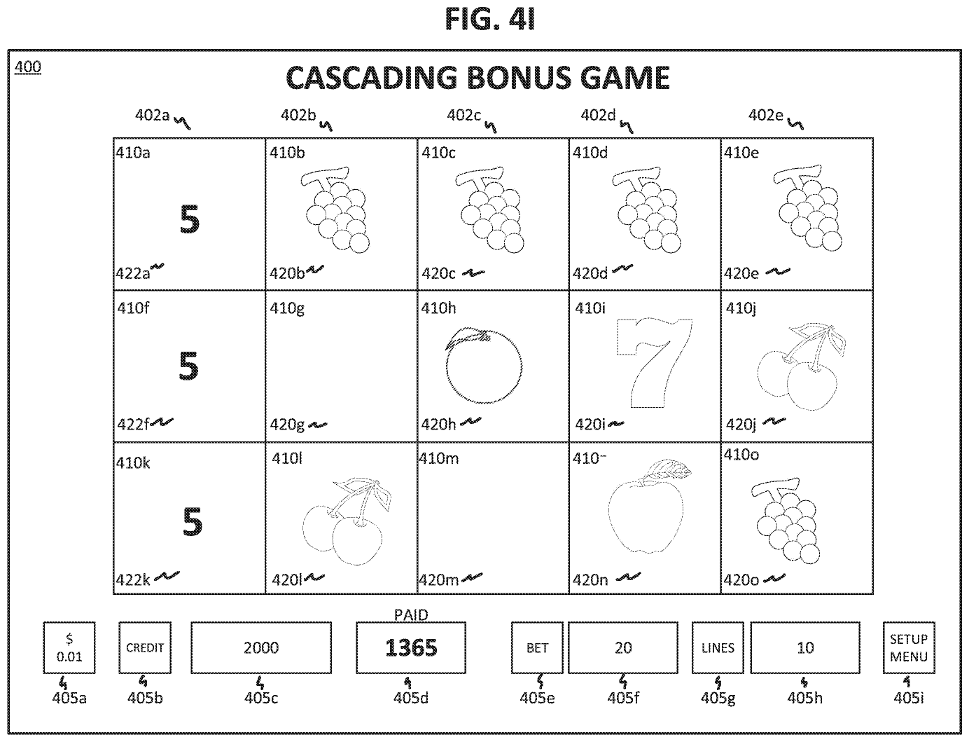

FIGS. 4A-4I illustrate screen shots of some implementations of a gaming system including a repeating free spin win accumulator where the gaming system generated one bonus game triggering symbol.

FIG. 4A illustrates some implementations of a game screen 400 that the gaming system 10 may display on a game display device of the gaming system. In some implementations, game screen 400 may be displayed on first display 122 of gaming system 10 illustrated in FIG. 1. However, any other suitable display may be used. The game screen 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game screen 400 is merely representative and may have more or fewer game elements shown in the game screen 400. It should also be appreciated that other games may be used for the primary or base game.

The plurality of reels 402a-402e are each associated with a set of symbols, where the set of symbols includes a plurality of symbols. Each reel 402a-402e is associated with a plurality of symbols of the set of symbols. Each reel 402a-402e can also be associated with the same or a different plurality of symbol combinations from the first set of symbols. The set of symbols may include numbers, letters, geometric figures, symbols, images, character, blank symbols (e.g., the absence of symbols), animations, or any other suitable graphical depiction. The symbols in the set of symbols may include pay symbols and special or designated symbols. In some implementations, the at least one predetermined symbol is a triggering symbol for a bonus game. In some implementations, at least one predetermined symbol must be generated on the reels to trigger the bonus game. In some implementations, when the gaming system generates more than one predetermined trigging symbol, the gaming system activates more features in the bonus game than when the gaming system generates one predetermined trigging symbol. In some implementations, the predetermined triggering symbol may be any one of the symbols in the set of symbols. The predetermined triggering symbol may be associated with only one function but may alternatively be associated with a plurality of different game functions.

Returning now to FIG. 4A, the game screen 400 depicts a plurality of symbol display areas 410a, 410b, 410c, 410d, 410e, 410f, 410g, 410h, 410i, 410j, 410k, 410l, 410m, 410n, and 410o. This plurality of symbol display areas can be associated in a manner that provides the appearance of reels. It should also be appreciated that the symbol display areas may not be associated with reels in some implementations. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine reels. In some implementations, the plurality of symbol display areas that provide the appearance of five reels may be arranged in a manner that visibly shows three symbol positions of each of the five reels. For example, the symbol display areas 410a-4010 are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 420o are associated with reel 402e. The arrangement illustrated in the implementation of FIG. 4A thus creates a visible display area of the reels 402a-402e comprising three visible symbol positions for each reel. When viewed together, reels 402a-402e appear like a 3-row by 5-column reel array in display 400. In other implementations, smaller or larger visible areas of the reels can be displayed. That is, the reels 402a-402e may show fewer or a larger number of visible symbol display areas. While symbol display areas are illustrated with defined boxes, it should be appreciated that in some implementations, the defined boxes are not visible to the player. It should also be appreciated that in some implementations, the symbol display areas are other shapes or not defined shapes.

Each reel 402a-402e may display a plurality of symbols that the gaming system generates from the sets of symbols in their respective symbol display areas as illustrated in FIG. 4A. In some implementations, the reels may be shown spinning in one direction to simulate slot machine reels. However, it should be appreciated that the reels may be shown spinning in any suitable direction. The reels may also be shown spinning in different directions in some implementations.

Game screen 400 also includes several information areas and buttons 405a-405i. These information areas and buttons 405a-405i are illustrated in a particular arrangement but may be arranged in any suitable manner in different implementations. In some implementations, game screen 400 may include more or fewer display areas and buttons 405a-405i than illustrated in FIG. 4A-4H. Information area 405a illustrates an example value of one credit for the game display displayed in game screen 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming system 10. Information area 405f illustrates that the player has selected to wager 20 credits. Button 405g illustrates a software button that the player can select to determine how many pay lines to wager on. It should be appreciated that the functionality of button 405g may also be replicated or replaced with a hardware button on the gaming system 10. Information area 405h illustrates that the player selected to wager on 10 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In some implementations, the gaming system randomly generates symbols from the set of symbols for reels 402a-402e, respectively. As noted above, the gaming system may rely on random generation performed by a pseudo RNG, a true RNG, or hardware RNG specifically designed for gaming systems. In some implementations, the gaming system may also update the player's credit meter (information area 405c) to reflect the player's available credit balance. As shown in FIG. 4B, the player's credit meter (information area 405c) was decremented by 20 credits from 2200 to 2000 to reflect the 20 credit wager the player placed for the play of the game.

The gaming system displays the generated symbols 420a-420o in symbol display areas 410a-410o as illustrated in FIG. 4B. Symbols 420a-420o displayed on reels 402a-402e illustrate the randomly generated symbols from the set of symbols after the reels have stopped spinning. As illustrated in FIG. 4B, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e.

As illustrated in FIG. 4B, the gaming system generated and displayed Grape symbols (420a, 420b, 420c, 420d, 420e, 420o), a TGI Freegames symbol (420f), blank symbols (420g, 420m), a Seven symbol (420i), Cherry symbols (420j, 420l), Orange symbols (420h, 420k), and an Apple symbol (420n) in the game screen 400. It should be appreciated that the displayed symbol combinations are merely for explanatory purposes and the gaming system may randomly generate any suitable combination of symbols based on defined symbol sets.

FIG. 4B further illustrates some implementations of a gaming system executing an evaluation of the generated symbols on reels 402a-402e for winning symbol combinations. As noted above, the player may have wagered on one or more pay lines (such as 10 pay lines shown in information area 405h). In some implementations, at least the active (wagered on pay lines) are evaluated for winning symbol combinations. Any suitable number of pay lines may be used to evaluate winning symbol combinations.

In the implementation illustrated in FIG. 4B, the gaming system evaluated the generated symbol combinations for winning symbol combinations. In FIG. 4B, the gaming system determined that a winning symbol combination is displayed across one wagered pay line. The pay line spans across a horizontal direction of symbol display areas including symbol display areas 410a, 410b, 410c, 410d, and 410e. In this implementation, the gaming system displayed five Grape symbols along a horizontal pay line on which the player had placed a wager. The gaming system determined the five Grape symbols form a winning symbol combination based on a pay table associated with the gaming system. The winning pay line is illustrated as pay line 445 in FIG. 4C across the winning row of reels 402a-402e.

As noted at block 362 of FIG. 3B, in some implementations, the gaming system may also evaluate the generated symbols on reels 402a-402e for bonus triggering symbols. In FIG. 4B, the gaming system determined that a TGI Freegames symbol (420f) was generated for the play of the game. In the illustrated implementation, the TGI Freegames symbol was designated as the bonus game triggering symbol. It should be appreciated that any other suitable symbol could be designed as the bonus game triggering symbol. As also illustrated in FIG. 4B, the gaming system highlighted the TGI Freegames symbol so that player understands that the player won a bonus game or other game features. It should be appreciated that the gaming system may highlight the bonus triggering symbol in any suitable manner. It should also be appreciated that the gaming system may not highlight the bonus triggering symbols in some implementations.

In some implementations, the gaming system may be required to generate more than one bonus triggering symbol to activate a bonus game. In other implementations, the features available in the bonus game may depend on the quantity of bonus triggering symbols that the gaming system generates. For example, as will be shown in FIG. 4C, because one bonus triggering symbol was generated, the gaming system unlocked one reel for the bonus game. In other implementations, one bonus triggering symbol may trigger the bonus game and unlock two or more reels (or alternatively, a predetermined quantity of symbol display areas—like six or seven symbol display areas). In some implementations, at least one bonus trigging symbol must be generated in the far most reel 402a (in any symbol display area) to trigger the bonus game. That is, if the at least one bonus triggering symbol is generated in reels 402b, 402c, 402d, or 402e, the gaming system may not activate the bonus game. However, in other implementations, the bonus triggering symbol may appear on any reel in any symbol display area to trigger the bonus game. In some implementations, the gaming system may evaluate the bonus triggering symbols from a right to left direction along the reels (rather than left to right along the reels).

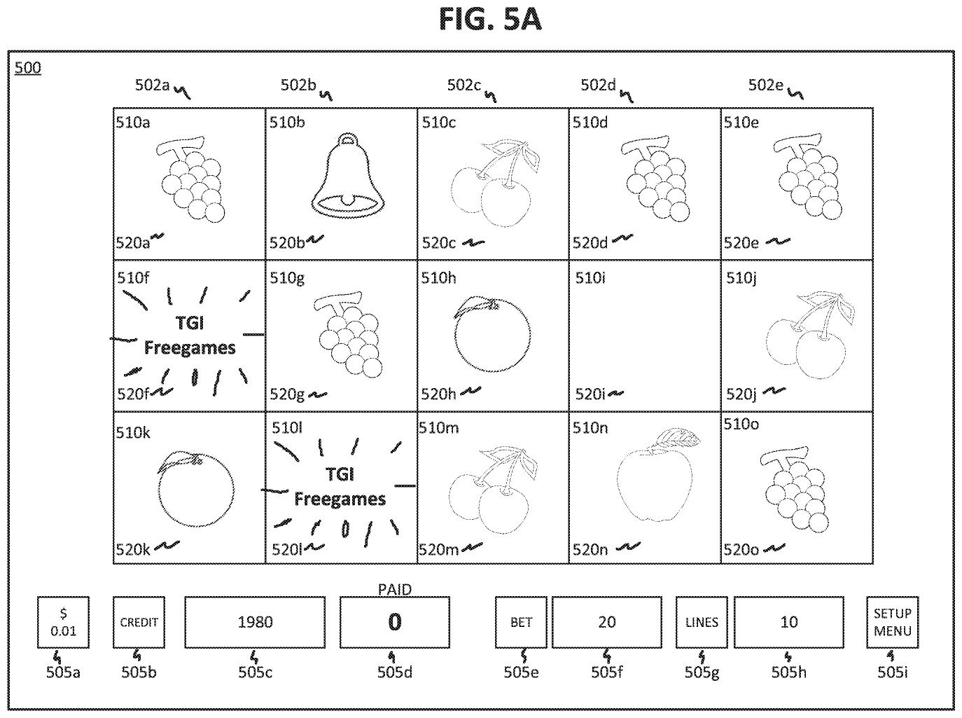

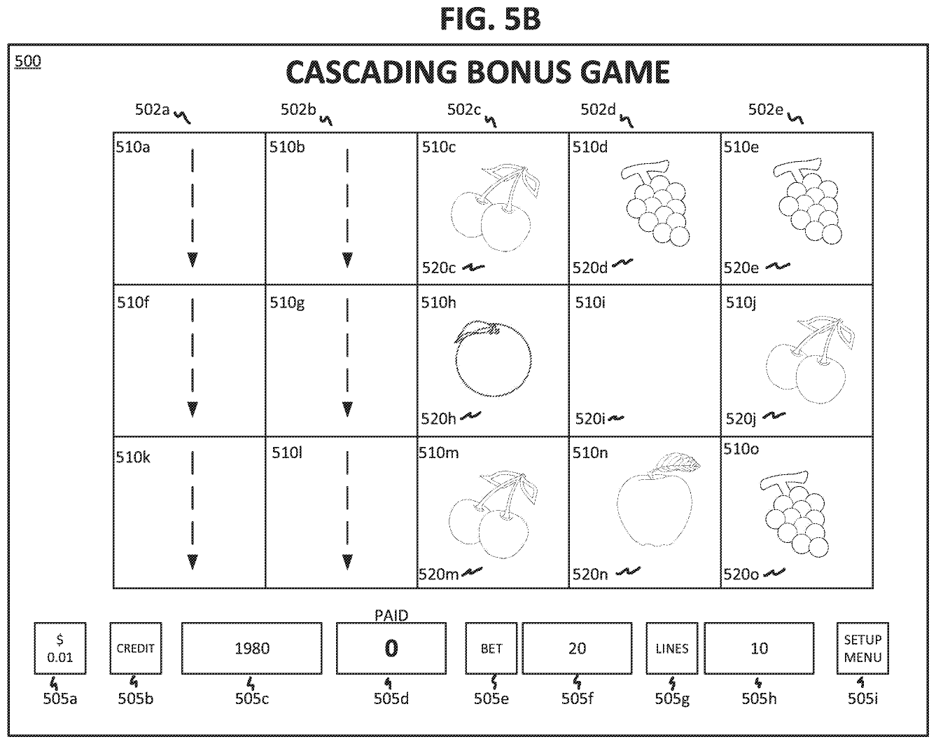

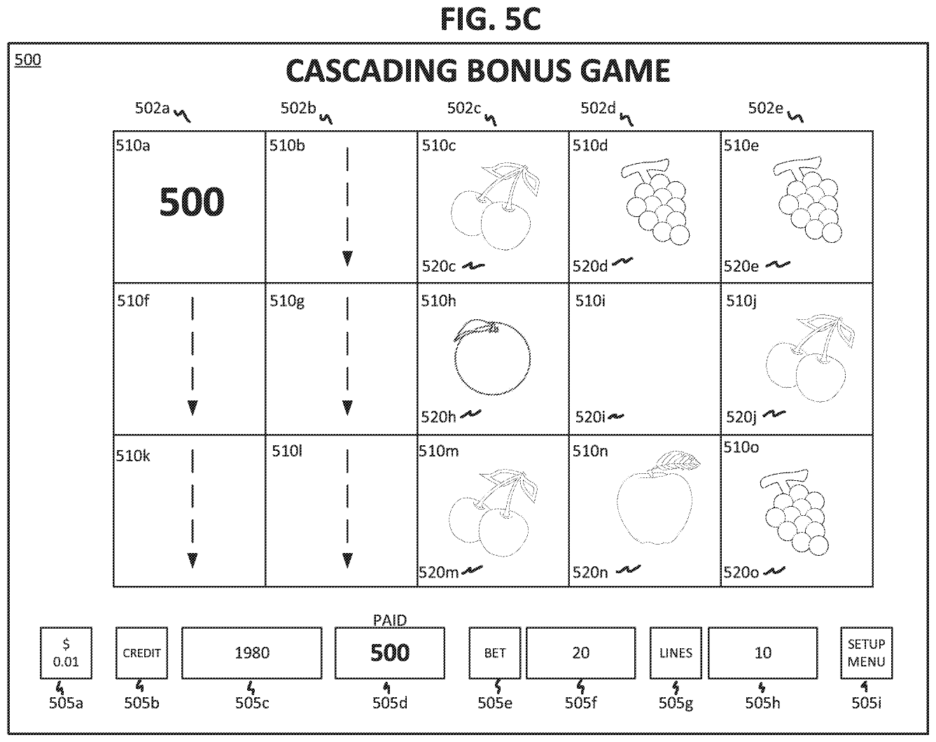

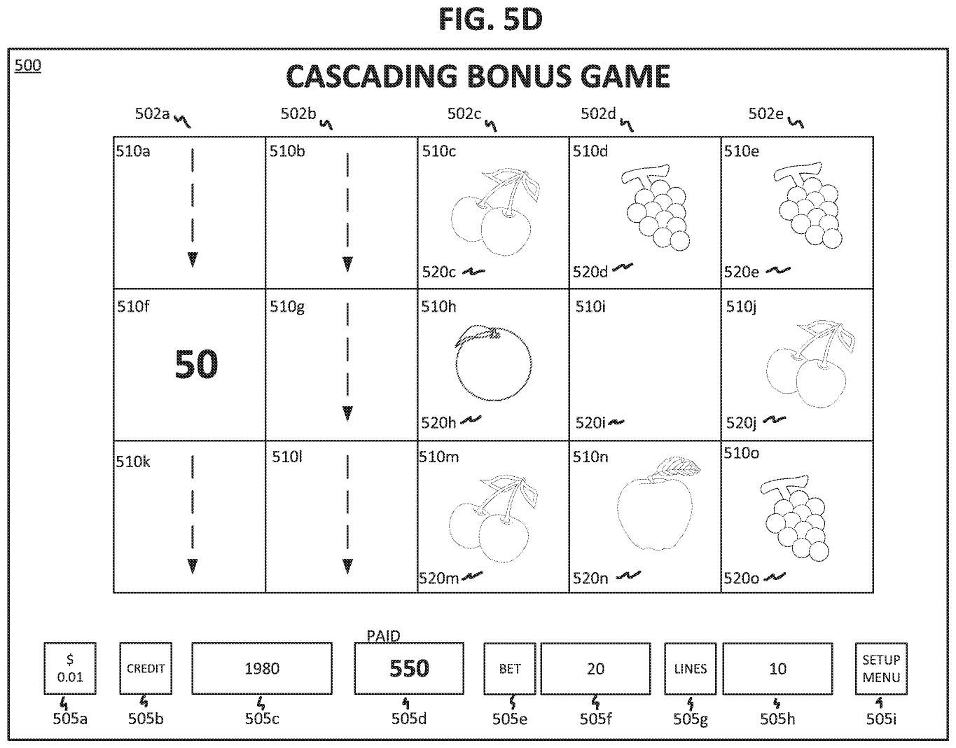

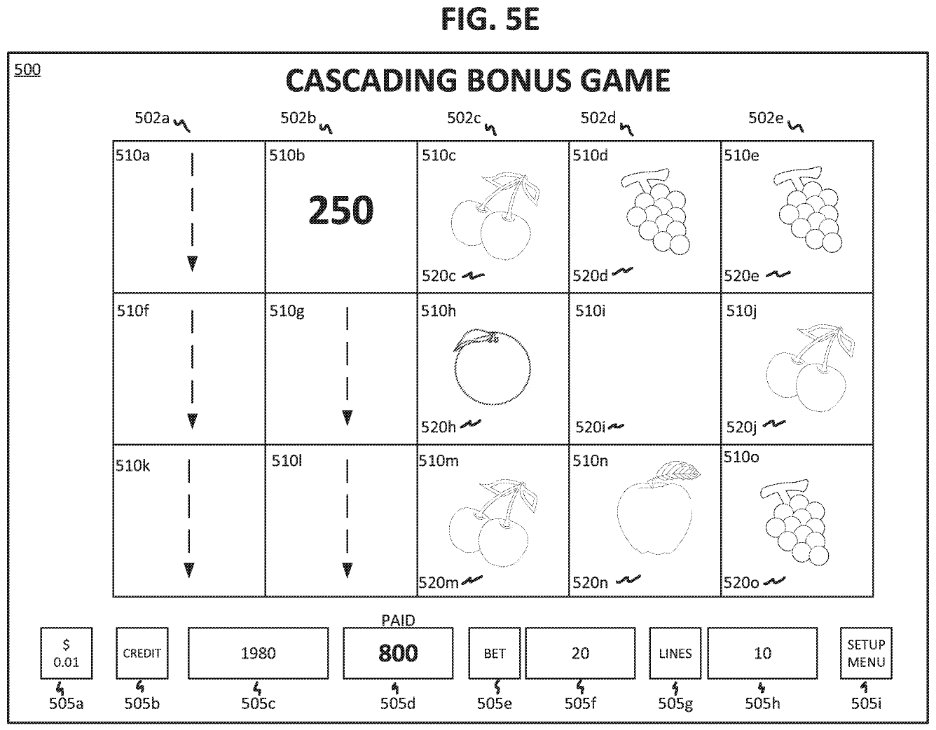

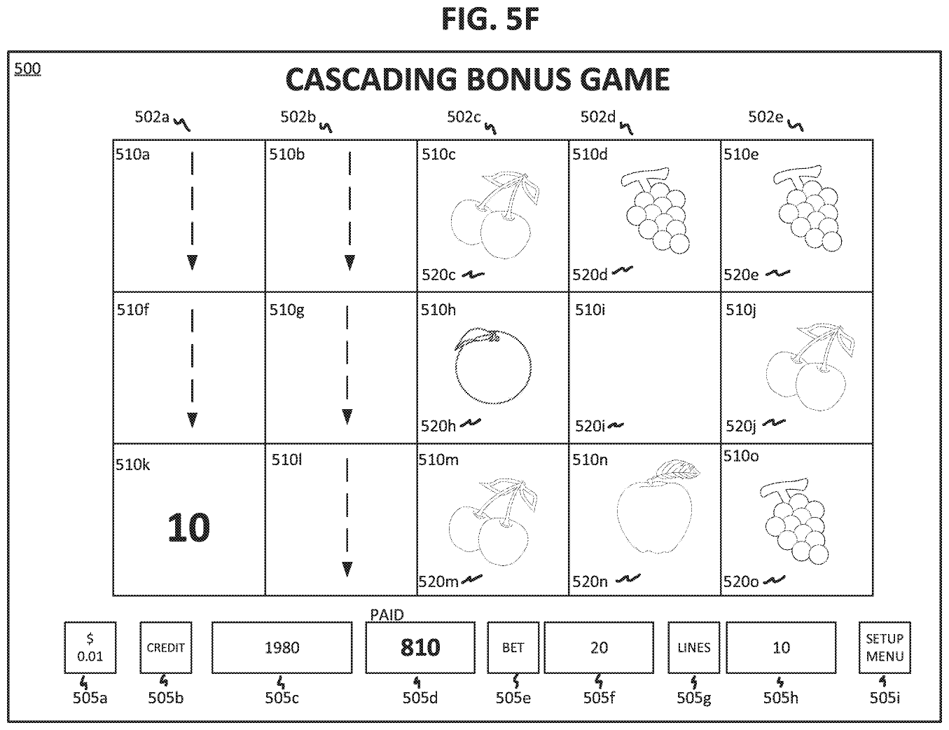

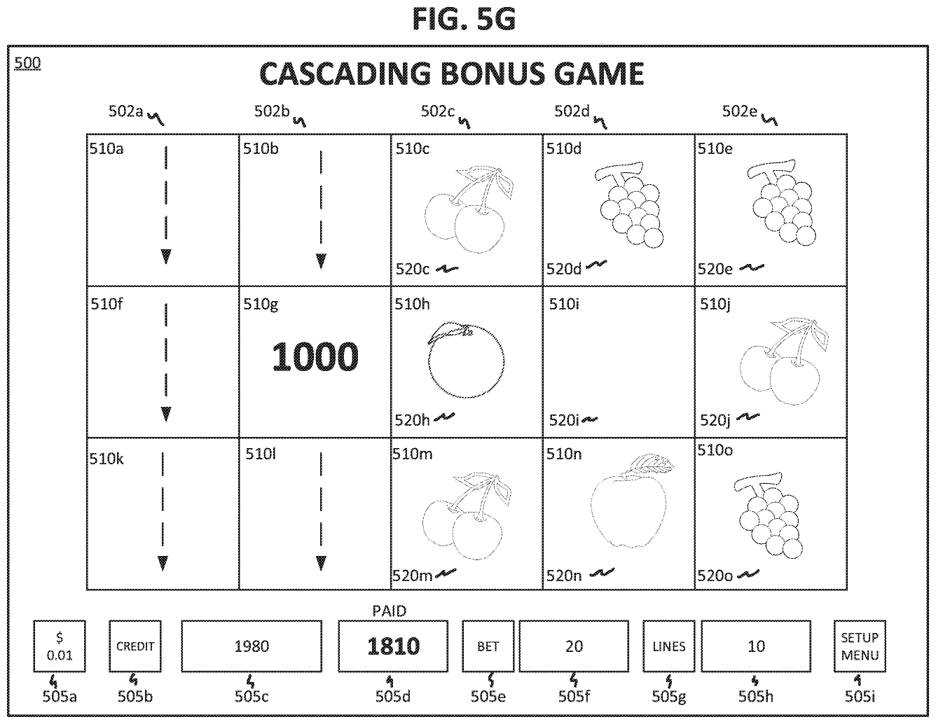

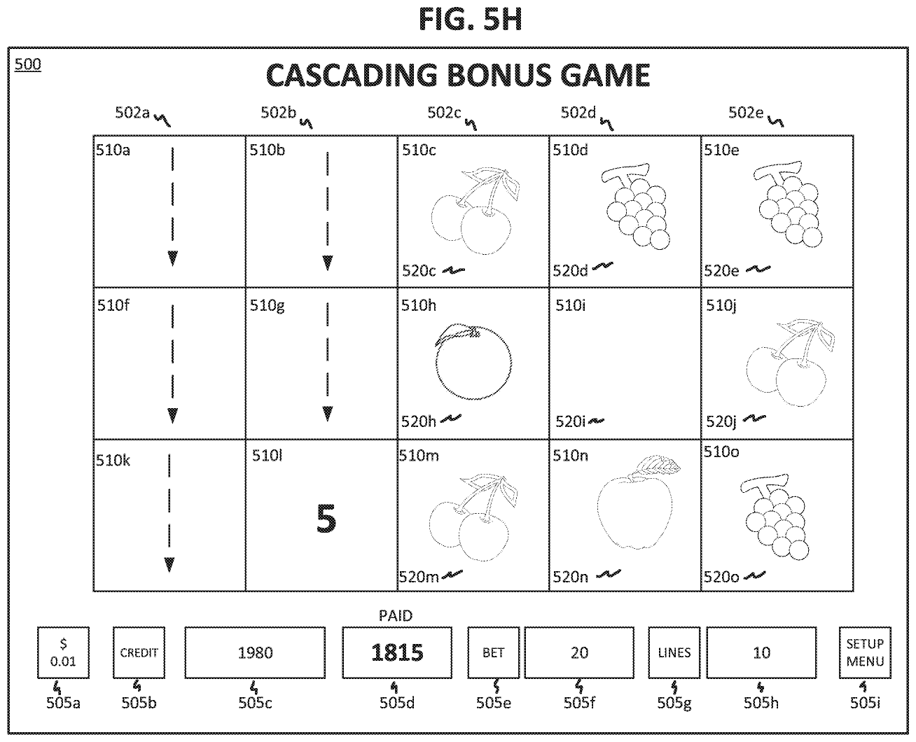

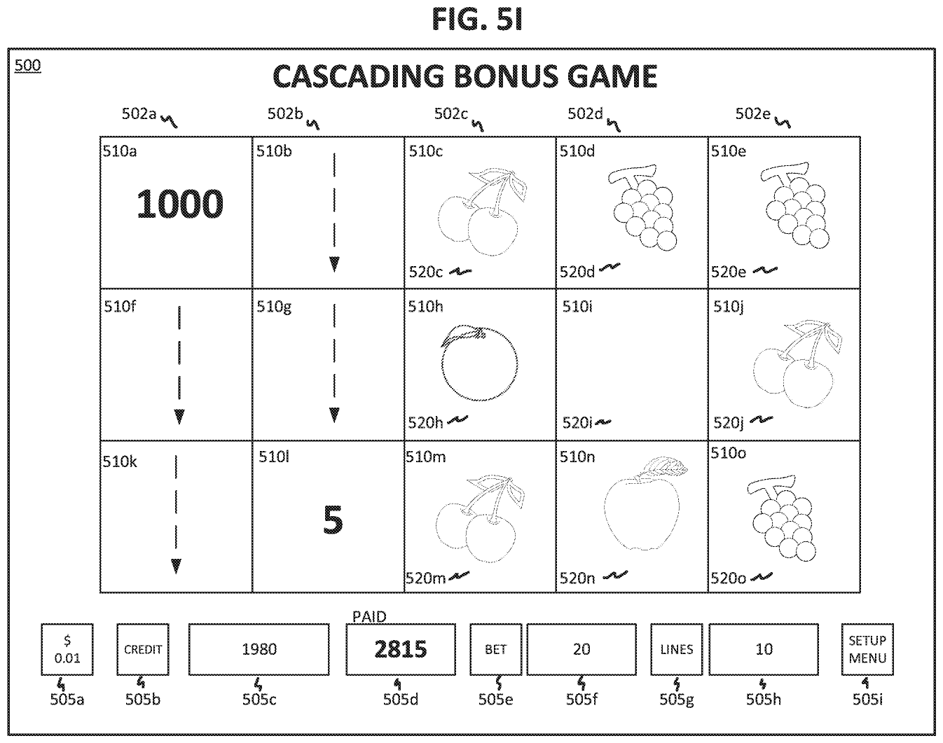

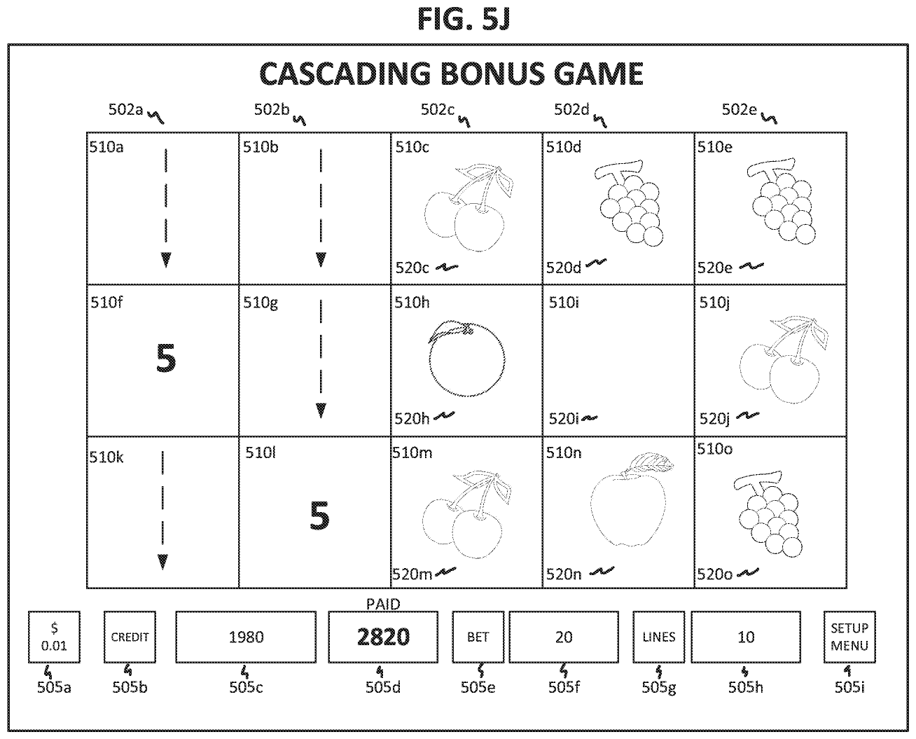

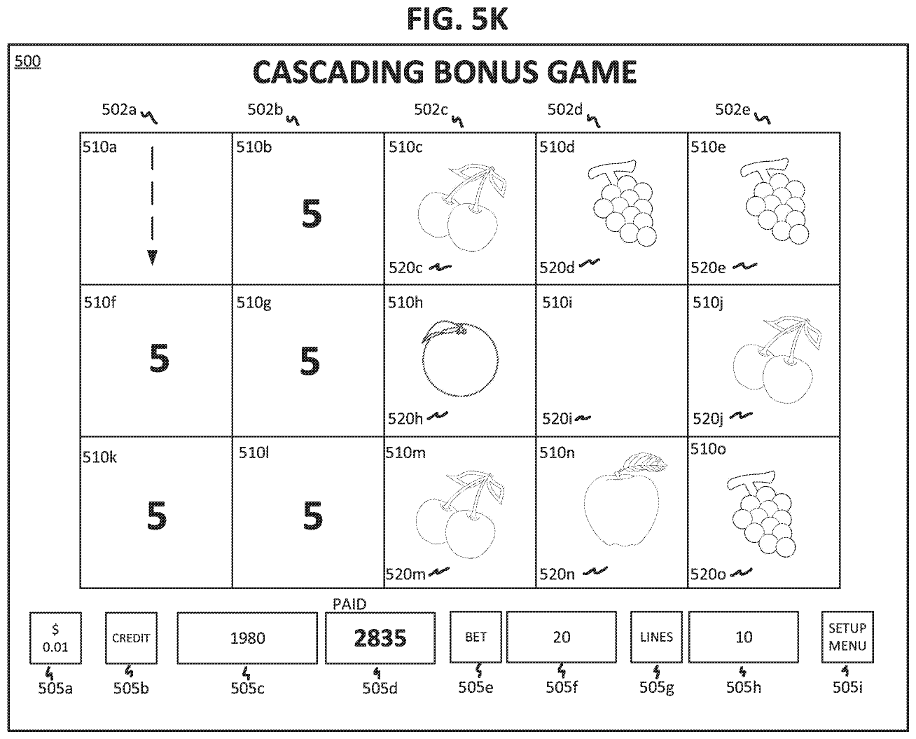

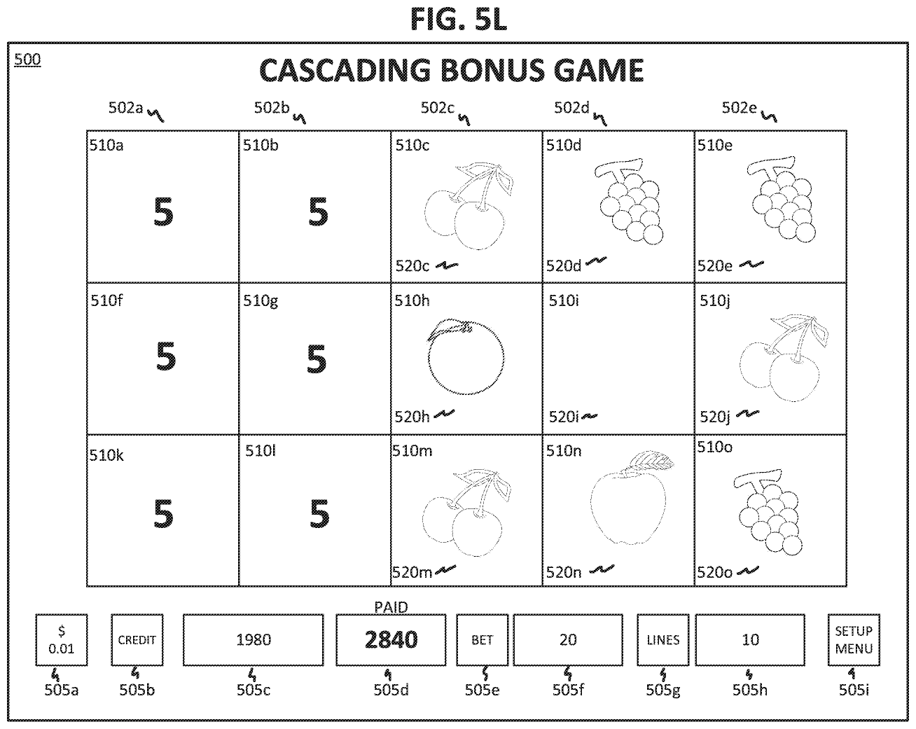

In some implementations, for more reels or more symbol display areas to become unlocked in the bonus game, the bonus triggering symbol must appear in adjacent reels starting from the far-left reel. For example, as will be discussed in connection with FIG. 5A, a gaming system generated two bonus triggering symbols in adjacent reels 502a and 502b when evaluated from the left most reel. In some implementations, unlocking additional reels requires the gaming system to generate at least one more bonus triggering symbol on reel 502c. Unlocking yet more reels like reel 502d and 502e may require the gaming system to generate bonus triggering symbols on reels 502d and 502e. However, in some implementations, the gaming system is not required to generate bonus triggering symbols on adjacent reels. That is, in some implementations, the gaming system may generate a bonus trigging symbol on reel 502b and 502e and still trigger the bonus game. In some implementations, the bonus triggering symbols activates the bonus game like a scatter symbol. In some implementations, the bonus triggering symbol activates the bonus game when evaluated along an active pay line. In other implementations, the gaming system does not require the bonus triggering symbols to appear on an active pay line to trigger the bonus game.

Returning now to FIG. 4C, the gaming system determined that one bonus triggering symbol (the TGI Freegames symbol 420f) was generated on reel 402a in symbol position 410f Based on the generated bonus triggering symbol on reel 402a, the gaming system activated a bonus game and unlocked one reel 402a for the bonus game. In alternative implementations, other reels can be unlocked for the bonus game. Reels 402b, 402c, 402d, and 402e remain locked for the bonus game, which means the gaming system will not generate symbols in the bonus game for these reels and associated symbol display areas. In some implementations, the gaming system keeps the symbols previously generated in the primary game display displayed for the bonus game. In alternative implementations, the gaming system may remove the symbols so that the previously generated symbols from the primary game are not displayed in the bonus game.

In some implementations, the gaming system associates a different set of symbols with each of the unlocked symbols display areas 410a, 410f, and 410k. Thus, the gaming system generates, using the RNG discussed above, symbols for each of symbol display areas 410a, 410f, and 410k from a different set of symbols in some implementations. Each of these different sets of symbols may include the same symbols associated with the same or different probabilities of being generated. In other implementations, these different sets of symbols may include different symbols. As previously noted, these sets of symbols may be the same as symbols from the base game or different from the base game. In some implementations, as will be illustrated in FIG. 4D-4I and FIG. 8, the set of symbols may comprise numbers or values. Each symbol or number may be associated with a probability of being generated in a game. In some implementations, the probability of a symbol or number being generated in a game may change based on the player's wager. For example, if the player placed a minimum wager, the gaming system may increase the probability that lower value symbols will be generated in the bonus game (or increase the quantity of lower values symbols in the set of symbols). Alternatively, if the player placed a wager higher than the minimum wager, the gaming system may increase the probability or weight that a higher value symbol will be generated in the bonus game (or increase the quantity of higher value symbols in the set of symbols). Likewise, if the player placed the maximum wager in a game in some implementations, the gaming system may assign a higher probably that a 1000 credit symbol will be generated during the bonus game than if the player placed a minimum wager (or include more 1000 credit symbols in the symbol set).

In some implementations, each reel is associated with one set of symbols such that the gaming system generates symbols for each symbol display area on a reel from the same set of symbols. For ease of discussion, a set of symbols used for the bonus game shall be referred to as the bonus symbol set.

Returning to FIG. 4C, the gaming system entered the bonus game and activated each of the unlocked symbol display areas 410a, 410f, and 410k. FIG. 4C illustrates the gaming system cycling or spinning symbols in each of the symbol display areas 410a, 410f, and 410k. In some implementations, the spinning symbols may appear like an individual reel spinning in each unlocked symbol display area. In this implementation, the directional arrows indicate the direction of the cycling or spinning symbols. However, any suitable direction may be used. In some implementations, each symbol display area spins or cycles through symbols in different directions. The gaming system may the generate symbols from each of the bonus symbol sets for each of the symbol display areas. In another implementation, the gaming system generates a symbol from a bonus symbol set as the gaming system is ready to display the generated symbol in a particular symbol display area.

In FIG. 4D the gaming system generated and displayed, from the bonus symbol set associated with symbol display area 410a, the 1000 symbol 422a. In this implementation, the 1000 symbol 422a is also associated with a value of 1000 credits. As shown in the information display area 405d, the gaming system updated the player's win meter to reflect the 1000 credit win.

In FIG. 4E, the gaming system generated and displayed, from the bonus symbol set associated with symbol display area 410f, the 100 symbol 422f In this implementation, the 100 symbol 422f is also associated with a value of 100 credits. As shown in the information display area 405d, the gaming system updated the player's win meter to reflect the 100 credit win (e.g., 1000 from symbol display area 410a+100 from symbol display area 410f). As also illustrated in FIG. 4E, the gaming system continued to display the 1000 symbol 422a, while generating and displaying the 100 symbol 422f In an alternative implementation, the gaming system may conceal prior generated symbols as the gaming system moves to the next unlocked symbol display area. In some such implementations, the gaming system will show cycling or spinning symbols in each of the unlocked symbol display areas that are not revealing a generated symbol.

In FIG. 4F, the gaming system generated and displayed, from the bonus symbol set associated with symbol display area 410k, the 250 symbol 422k. In this implementation, the 250 symbol 422k is also associated with a value of 250 credits. As shown in the information display area 405d, the gaming system updated the player's win meter to reflect the new 250 credit win (e.g., rising to 1350 credits won in the bonus game). As also illustrated in FIG. 4F, the gaming system continued to display the 1000 symbol 422a and the 100 symbol 422f while generating and displaying the 100 symbol 422f It should be appreciated that in the illustrated implementation, the unlocked symbols were displayed sequentially and in a cascading format.

In some implementations, the gaming system may evaluate all of the generated and displayed awards before, during, or after the awards are displayed to update the player's win meter. The gaming system may also evaluate each of the generated symbols to determine if any of the symbols will cause an associated symbol display area to become locked. In this implementation, the lock symbol is the lowest value symbol in the bonus set of symbols. As illustrated in FIG. 8, the 5 symbol is set as the lock symbol 810. However, in the illustration of FIG. 4F, the gaming system evaluates the symbols and determines that no lock symbol was generated for an unlocked symbol display area. As such, the gaming system may continue the play of the game and generate at least one more symbol from the associated bonus symbol set for each unlocked symbol display area.

As illustrated in FIG. 4G, the gaming system generated and displayed, from the bonus symbol set associated with symbol display area 410a, the “5” symbol. In this implementation, the 5 symbol is associated with a value of 5 credits. As shown in the information display area 405d, the gaming system updated the player's win meter to reflect the new 5 credit win (e.g., rising to 1355 credits won in the bonus game). In this implementation, the 5 symbol is also associated with the lock symbol. Because the gaming system generated a lock symbol in unlocked symbol display area 410a, the gaming system also locked symbol display area 410a for the remainder of the game. In some implementations, the gaming system does not generate another symbol from the associated bonus symbol set for display area 410a. However, it should be appreciated that in some implementations, the gaming system may unlock symbol display area 410a if certain triggering events occur.

As illustrated in FIG. 4H, the gaming system moved on to symbol display area 410f. The gaming system generated and displayed, from the bonus symbol set associated with symbol display area 410f, the “5” symbol. In this implementation, the 5 symbol is associated with a value of 5 credits. As shown in the information display area 405d, the gaming system updated the player's win meter to reflect the new 5 credit win (e.g., rising to 1360 credits won in the bonus game). In this implementation, the 5 symbol is also associated with the lock symbol. Because the gaming system generated a lock symbol in unlocked symbol display area 410f, the gaming system also locked symbol display area 410f for the remainder of the game. In some implementations, the gaming system does not generate another symbol from the associated bonus symbol set for display area 410f. However, it should be appreciated that in some implementations, the gaming system may unlock symbol display area 410f if one or more certain triggering events occur. It should also be appreciated that the symbols shown in the figures are for illustration purposes and do not limit the symbols that can be generated in a game. For example, the gaming system may have also generated a nonlocking symbol for symbol display areas 410a and 410f for FIGS. 4G and 4H. Thus, in an alternative implementation, the symbols display areas 410a and 410f may continue to be unlocked and receive additionally generated symbols from the bonus symbol set for the play of the game.

Returning to FIG. 4I, the gaming system moved on to symbol display area 410k. The gaming system generated and displayed, from the bonus symbol set associated with symbol display area 410k, the “5” symbol. In this implementation, the 5 symbol is associated with a value of 5 credits. As shown in the information display area 405d, the gaming system updated the player's win meter to reflect the new 5 credit win (e.g., rising to 1365 credits won in the bonus game). In this implementation, the “5” symbol is also associated with the lock symbol. Because the gaming system generated a lock symbol in unlocked symbol display area 410k, the gaming system locked symbol display area 410k for the remainder of the game.

In the illustrated implementation, no unlocked symbol display areas remain. Therefore, the gaming system does not generate additional symbols for symbol display areas from the bonus symbol sets. The play of the game ends.

FIGS. 5A-5L illustrate screen shots of some implementations of a gaming system including a repeating free spin win accumulator where the gaming system generated a plurality of bonus game triggering symbols.

For the sake of brevity, the primary game in FIGS. 5A-5L may operate similar to the primary game discussed in FIG. 4A-4B. In alternative implementations, the primary game can be a different game. As also noted above, while the repeating free spin win accumulator is depicted as a bonus game, the repeating free spin win accumulator may be applied in a primary game.

Turning to FIG. 5A, the gaming system displays the generated symbols 520a-520o in symbol display areas 510a-510o as illustrated in FIG. 5A. Symbols 520a-520o displayed on reels 502a-502e illustrate the randomly generated symbols from the set of symbols after the reels have stopped spinning. As illustrated in FIG. 5A, the gaming system randomly generated and displayed symbols 520a, 520f, and 520k in symbol display areas 510a, 510f, and 510k for reel 502a. The gaming system also randomly generated and displayed symbols 520b, 520g, and 520l in symbol display areas 510b, 510g, and 510l for reel 502b; symbols 520c, 520h, and 520m in symbol display areas 510c, 510h, and 510m for reel 502c; symbols 520d, 520i, and 520n in symbol display area 510d, 510i, and 510n for reel 502d; symbols 520e, 520j, and 520o in symbol display area 510e, 510j, and 510o for reel 502e.

FIG. 5A further illustrates some implementations of a gaming system executing an evaluation of the generated symbols on reels 502a-502e for winning symbol combinations. As noted above, the player may have wagered on one or more pay lines (such as 10 pay lines shown in information area 505h). In some implementations, at least the active (wagered on pay lines) are evaluated for winning symbol combinations. Any suitable number of pay lines may be used to evaluate winning symbol combinations.

In the implementation illustrated in FIG. 5A, the gaming system evaluated the displayed symbol combinations for winning symbol combinations. In FIG. 5A, the gaming system determined that no winning symbol combinations were displayed across any active pay lines.

As noted at block 362 of FIG. 3B, in some implementations, the gaming system may also evaluate the generated symbols on reels 502a-502e for bonus triggering symbols. In FIG. 5A, the gaming system determined that two TGI Freegames symbols (520f and 520l) were generated for the play of the game. In the illustrated implementation, the TGI Freegames symbol was designated as the bonus game triggering symbol. As also illustrated in FIG. 5A, the gaming system highlighted the TGI Freegames symbols so that player understands that the player won a bonus game or other game features. It should be appreciated that the gaming system may highlight the bonus triggering symbol in any suitable manner. It should also be appreciated that the gaming system may not highlight the bonus triggering symbols in some implementations. As noted in the discussion of FIG. 4A-4I, because two bonus triggering symbols were generated, the gaming system unlocks more reels than were unlocked in FIG. 4A-4I.

Returning now to FIG. 5B, the gaming system determined that two bonus triggering symbols (the TGI Freegames symbol 520f and 520l) were generated on adjacent reels 502a and 502b in symbol positions 510f and 510l, respectively. Based on the generated bonus triggering symbols on reels 502a and 502b, the gaming system activated a bonus game and unlocked two reels 502a and 502b for the bonus game. In alternative implementations, other reels can be unlocked for the bonus game. For example, reels 502a, 502b, and 502c may be unlocked in some implementations. As another example, reels 502a, 502b, and 502d may be unlocked.

For illustration purposes in FIG. 5B-5L, reels 502c, 502d, and 502e remain locked for the bonus game, which means the gaming system will not generate symbols in the bonus game for these reels and associated symbol display areas.

In some implementations, the gaming system associates a different bonus symbol set with each of the unlocked symbols display areas 510a, 510f, 510k, 510b, 510g, and 510l. Thus, the gaming system generates, using the RNG discussed above, symbols for each of symbol display areas 510a, 510f, 510k, 510b, 510g, and 510l from a different set of symbols. It should be appreciated that the compositions of the symbols in the bonus symbol sets and the quantity of bonus symbols sets may vary similar to the variations discussed in connection with FIG. 4A-4I.

Returning to FIG. 5B, the gaming system entered the bonus game and activated each of the unlocked symbol display areas 510a, 510f, 510k, 510b, 510g, and 510l. FIG. 5B illustrates the gaming system cycling or spinning symbols in each of the symbol display areas 510a, 510f, 510k, 510b, 510g, and 510l. The spinning symbols may appear like individual reels in each of symbol display areas 510a, 510f, 510k, 510b, 510g, and 510l. In this implementation, the directional arrows indicate the direction of the cycling or spinning symbols. However, any suitable direction may be used. In some implementations, each symbol display area spins or cycles through symbols in different directions. The gaming system may the generate symbols from each of the bonus symbol sets for each of the symbol display areas. In another implementation, the gaming system generates a symbol from a bonus symbol set as the gaming system is ready to display the generated symbol in a particular symbol display area.

As will be shown in FIG. 5C-5L, the gaming system generates and displays the symbols for the bonus game in a cascading or waterfall format.

In FIG. 5C, the gaming system generated and displayed, from the bonus symbol set associated with symbol display area 510a, the “500” symbol. In this implementation, the 500 symbol is also associated with a value of 500 credits. As shown in the information display area 505d, the gaming system updated the player's win meter to reflect the 500 credit win.

In FIG. 5D, the gaming system generated and displayed, from the bonus symbol set associated with symbol display area 510f, the “50” symbol. In this implementation, the 50 symbol is also associated with a value of 50 credits. As shown in the information display area 505d, the gaming system updated the player's win meter to reflect the additional 50 credit win. As also illustrated in FIG. 5D, the gaming system did not continue to display the “500” symbol previously generated for symbols display area 510a, while generating and displaying the “50” symbol. Instead, the gaming system illustrates cycling or spinning symbols in each of the unlocked symbol display areas that are not revealing a generated symbol. In an alternative implementation, the gaming system may continue to display each generated and displayed symbol as the gaming system moves to the next unlocked symbol display area (as discussed in connection with FIG. 4A-4I). It should also be appreciated that to create the cascading or waterfall effect, the gaming system generated and displayed a symbol in symbol display area 510b before 510k.

In FIG. 5E, the gaming system generated and displayed, from the bonus symbol set associated with symbol display area 510b, the “250” symbol. In this implementation, the 250 symbol is also associated with a value of 250 credits. As shown in the information display area 505d, the gaming system updated the player's win meter to reflect the new 250 credit win (e.g., rising to 800 credits won in the bonus game). As also illustrated in FIG. 5E, the gaming system removed the previously revealed win from symbol display area 510f.

As illustrated in FIG. 5F, the gaming system generated and displayed, from the bonus symbol set associated with symbol display area 510k, the “10” symbol. In this implementation, the 10 symbol is associated with a value of 10 credits. As shown in the information display area 505d, the gaming system updated the player's win meter to reflect the new 10 credit win (e.g., rising to 810 credits won in the bonus game).

As illustrated in FIG. 5G, the gaming system moved to symbol display area 510g. The gaming system generated and displayed, from the bonus symbol set associated with symbol display area 510g, the 1000 symbol. In this implementation, the 1000 symbol is associated with a value of 1000 credits. As shown in the information display area 505d, the gaming system updated the player's win meter to reflect the new 1000 credit win (e.g., rising to 1810 credits won in the bonus game).

As illustrated in FIG. 5H, the gaming system moved to symbol display area 510l. The gaming system generated and displayed, from the bonus symbol set associated with symbol display area 510l, the “5” symbol. In this implementation, the 5 symbol is associated with a value of 5 credits. As shown in the information display area 505d, the gaming system updated the player's win meter to reflect the new 5 credit win (e.g., rising to 1815 credits won in the bonus game). In FIG. 5H, the 5 symbol is also associated with the lock symbol (in accordance with the pay table from FIG. 8 associated with this game). Because the gaming system generated a lock symbol in unlocked symbol display area 510l, the gaming system also locked symbol display area 510l for the remainder of the game. In some implementations, the gaming system does not generate another symbol from the associated bonus symbol set for display area 510l. However, it should be appreciated that in some implementations, the gaming system may unlock symbol display area 510l if one or more triggering events occur (such as the gaming system generating a free spin award).

With the generation and display of the symbol in symbol display area 510l, the gaming system generated a first round of symbols from the associated bonus symbol sets for each of the initially unlocked symbol display areas. The gaming system evaluates the symbol display areas to determine if any symbol display area remains unlocked. As illustrated in FIG. 5H, five symbol display areas remain unlocked. As such, the gaming system continues to sequentially generate and display symbols for the unlocked symbol display areas. In some implementations, the generation and display pattern remains the same. In alternative implementations, the order in which the gaming system generates and displays symbols can be modified.

Returning to FIG. 5I, the gaming system returned to symbol display area 510a. The gaming system generated and displayed, from the bonus symbol set associated with symbol display area 510a, the 1000 symbol. In this implementation, the 1000 symbol is associated with a value of 1000 credits. As shown in the information display area 505d, the gaming system updated the player's win meter to reflect the new 1000 credit win (e.g., rising to 2815 credits won in the bonus game). In this implementation, the 1000 symbol is not associated with the lock symbol. Thus, symbol display area 510a remains unlocked for at least one additional symbol generation later in the game.

In FIG. 5J, the gaming system moved to symbol display area 510f again. The gaming system generated and displayed, from the bonus symbol set associated with symbol display area 510f, the “5” symbol. In this implementation, the 5 symbol is associated with a value of 5 credits. As shown in the information display area 505d, the gaming system updated the player's win meter to reflect the new 5 credit win (e.g., rising to 2820 credits won in the bonus game). In this implementation, the 5 symbol is associated with the lock symbol. Thus, symbol display area 510k becomes locked and cannot receive additional symbol generations for the remainder of the game.

For the sake of brevity, illustrations of the gaming system moving to symbol display areas 510b, 510k, and 510g are not shown. However, FIG. 5K illustrates that the gaming system generated the “5” symbol in each of the symbol display areas 510b, 510k, and 510g to lock these symbol display areas. As shown in the information display area 505d, the gaming system updated the player's win meter to reflect the new 5 credit wins (e.g., rising to 2835 credits won in the bonus game). Because the gaming system did not generate a lock symbol in symbol display area 510a, the symbol display area 510a remains unlocked for yet another generation and display of symbols from the associated bonus symbol set.

As shown in FIG. 5L, the gaming system generated the “5” symbol for symbol display area 510a in the next generation of symbols. As shown in the information display area 505d, the gaming system updated the player's win meter to reflect the new 5 credit win (e.g., rising to 2840 credits won in the bonus game). In this implementation, the 5 symbol is associated with the lock symbol. Thus, symbol display area 510a remains locked for additional symbol generations later in the game.

In the illustrated implementation, no unlocked symbol display areas remain. Therefore, the gaming system does not generate additional symbols for the symbol display areas from the bonus symbol set. The play of the game ends.

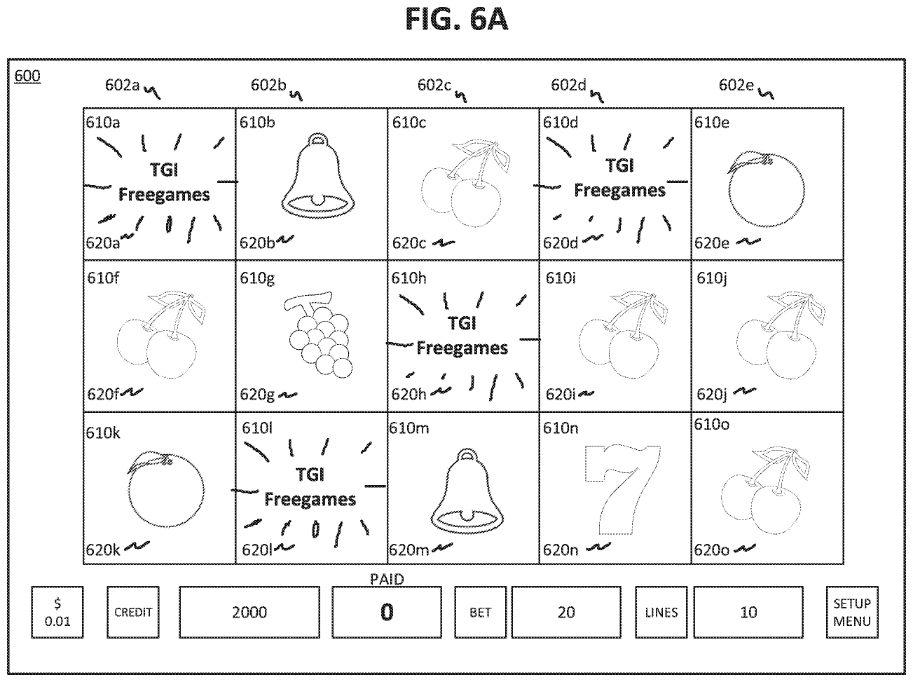

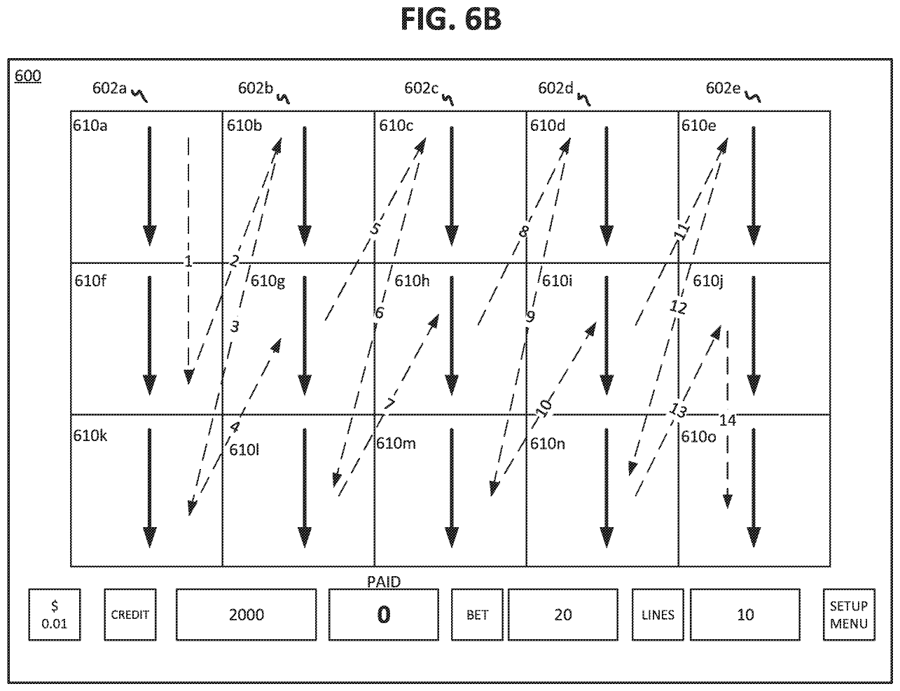

It should be appreciated that in the illustrated implementation, the gaming system displayed the unlocked symbols in a sequential and in a cascading format. To further illustrate the sequential and cascading format, FIGS. 6A and 6B illustrate all of the reels and all of the symbol display areas being unlocked for the bonus game.

In FIG. 6A, the gaming system generated one TGI Freegames symbol (the bonus triggering symbol) in each of reels 602a, 602b, 602c, and 602d. In this implementation, the gaming system unlocks all reels due to the generation of four bonus triggering symbols across four adjacent reels. It should be noted that the four bonus triggering symbols were not generated along an active pay line, but the gaming system still activates a bonus game (i.e., four bonus triggering symbols displayed anywhere on four adjacent reels). In some implementations, one bonus triggering symbol unlocks one reel, thus five bonus triggering symbols may be required to unlock five reels.

FIG. 6B illustrates some implementations of a sequential and cascading format for the bonus game. The gaming system unlocked all reels 602a, 602b, 602c, 602d, and 602e and all associated symbols display areas 610a, 610b, 610c, 610d, 610e, 610f, 610g, 610h, 610i, 610j, 610k, 6101, 610m, 610n, and 610o. The solid arrows in each of the symbols display areas 610a-610o illustrate the gaming system cycling or spinning symbols. The dashed line arrows 1, 2, 3, 4, 5, 6, 7, 8, 9, 10, 11, 12, 13, and 14 illustrate one order the gaming system uses to generate and display symbols in the unlocked symbol display areas 610a-610o. For example, the gaming system may generate and display symbols in the bonus game for symbol display position 610a then 610f. Subsequently, the gaming system may generate and display a symbol for symbol display position 610b. The gaming system may follow the numeric order of the dashed line arrows until generating and displaying a symbol for symbol display position 610o. It should be appreciated that in some implementations, the gaming system may generate all of the symbols for display in their respective symbol display positions before displaying the generated symbols. As with the examples illustrated in FIGS. 4A-4I and 5A-5L, the gaming system may continue to generate symbols for any unlocked symbol display area, cycling through the symbol display areas in the order shown in FIG. 6B in successive cycles (but skipping over locked symbol display areas), until all symbol display areas are locked (or no unlocked symbol display areas remain).

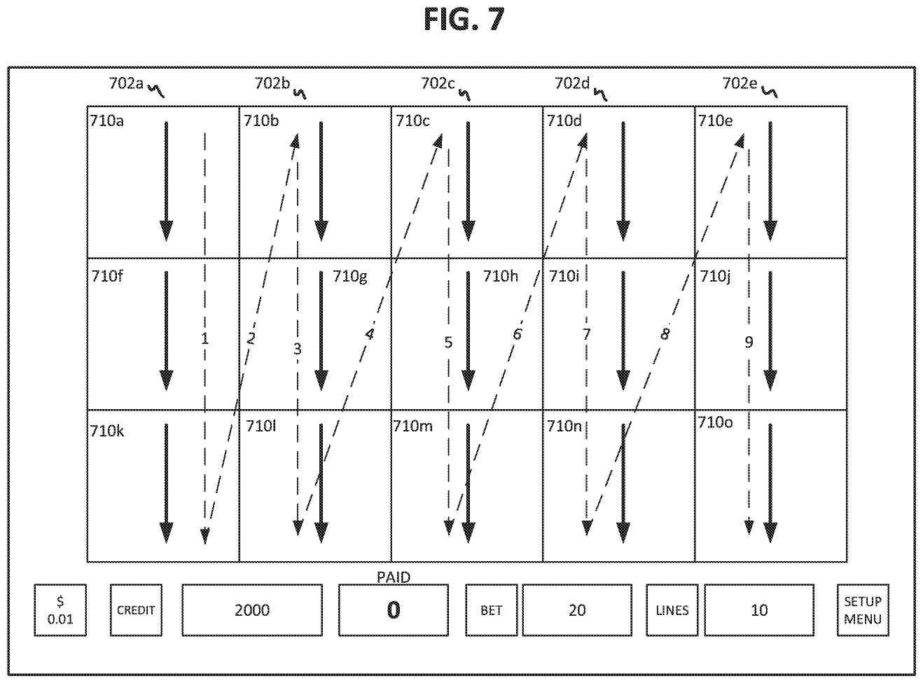

FIG. 7 is similar to FIG. 6B, except in FIG. 7, the order that the gaming system uses to generate and display the symbols differs from FIG. 6B. It should therefore be appreciated that the gaming system may generate and display the symbols in unlocked symbol display areas in any suitable format. In FIG. 7, the gaming system unlocked all reels 702a-702e and all associated symbols display areas 710a, 710b, 710c, 710d, 710e, 710f, 710g, 710h, 710i, 710j, 710k, 710l, 710m, 710n, and 710o. The solid arrows in each of the symbols display areas 710a-710o illustrate the gaming system cycling or spinning symbols. It should be appreciated that while the solid arrows show spinning in one direction, the spinning may occur in any direction. The dashed line arrows 1, 2, 3, 4, 5, 6, 7, 8, and 9 illustrate one order the gaming system may use to generate and display symbols in the unlocked symbol display areas 710a-710o. For example, the gaming system may generate and display symbols in the bonus game for symbol display positions 710a then 710f then 710k. Subsequently, the gaming system may generate and display a symbol for symbol display position 710b. The gaming system may follow the numeric order of the dashed line arrows until generating and displaying a symbol for symbol display position 710o. As with the examples illustrated in FIGS. 4A-4I, 5A-5L, and 6A-6B, the gaming system may continue to generate symbols for any unlocked symbol display area, cycling through the symbol display areas in the order shown in FIG. 7, until no unlocked symbol display areas remain.

As detailed previously, a gaming system consistent with the present disclosure can include several game phases and features, including a bonus game having a repeating free spin win accumulator, and a game feature using expanded symbol display areas. In some implementations, the gaming system can provide the several game phases and features together using a single game screen provided on a single display device (e.g., display device 120). In other implementations, the gaming system can provide the several game phases and features using multiple game screens, which can be split between multiple display devices (e.g., display devices 120, 130, and 134). Upon a triggering event during a base game (e.g., a first phase), the gaming system can initiate a bonus game (e.g., a second phase or feature), having the repeating free spin win accumulator displayed in unlocked symbol display areas. In some implementations, the triggering event may include the gaming system generating at least one predetermined triggering symbol or a least one combination of predetermined triggering symbols. In other implementations, the bonus game can be triggered by other events, such as a time event or a random selection. For the individual unlocked symbol display area, the gaming system can randomly determine and display a symbol from a set of symbols. In some implementations, the randomly determined symbols of the bonus game are each associated with a corresponding monetary value. In some implementations, during the bonus game, the gaming system displays symbols that are the same or similar to those used in the base game and converts the displayed symbols to credit symbols. For example, the symbols of the base game can be fruit symbols, the credit symbols can be represent monetary values, and the conversion may be based on a predetermined correspondence between the fruit symbols and respective credit symbols.

Additionally, upon a predetermined triggering event, the gaming system can initiate an expansion feature (e.g., a bonus game) in which the gaming system expands the game screen by adding one or more symbol display areas. The triggering event may the same or a different than the triggering event the used for the bonus game. In implementations in which the gaming system is a slot machine having multiple reels, a display of one or more expansion trigger symbols may add additional symbol display positions to the reels that include an expansion trigger symbol. For example, if one of the reels initially included three symbol display areas, the gaming machine may add a fourth symbol display area to above or below that reel in response to the reel displaying the expansion trigger symbol in one of the three original symbol display areas. In some implementations, the quantity of symbol display areas added can correspond to the number of expansion trigger symbols displayed. For example, if a first reel of the slot machine game screen displays two expansion trigger symbols, then the gaming system may add two symbol display areas to that reel. Additionally, if a second reel displayed a single expansion trigger symbol, then the second reel may add one symbol display area to that reel. In some implementations, only expansion trigger symbols displayed in an active (e.g., wagered) pay line trigger the addition of symbol display areas.

FIGS. 9A, 9B, 9C, and 9D illustrate a flow block diagram for an example method 900 of a gaming system (e.g., gaming system 10) in accordance with aspects of the present disclosure. FIGS. 9A and 9B depict a base game of the gaming system. FIGS. 9C and 9D depict a a bonus game using a repeating free spin win accumulator, and an expansion feature, which may expand the symbol display areas of a game screen. In some implementations, the bonus game and the expansion feature can be triggered by the same event, such as the display of a predetermined trigger symbol. It is understood that the operations shown in FIGS. 9C and 9D may be included with those of FIGS. 9A and 9B, without initiating a separate bonus game or other game phase in response a triggering symbol or symbols. For example, the gaming system can randomly trigger the bonus game and the expansion feature.

Turning to FIG. 9A, at block 905, the gaming system (e.g., using processor 202 executing game module 205) can receive a monetary value from a player, in a same or similar manner to that previously described herein with respect to block 305 of FIG. 3A. For example, the gaming system may receive monetary value via a value acceptor device (e.g., value acceptor device 225). At block 907, the gaming system determines a credit balance based on the monetary value received from the player at block 905, in a same or similar manner to that previously described herein with respect to block 310 of FIG. 3B. At block 909, the gaming system may receive a wager for a play of a game in a same or similar manner to that previously described herein with respect to block 315 of FIG. 3A. For example, the gaming system may receive the wager an input device (e.g., one of input devices 115). At block 911, the gaming system can update the credit balance determined at block 907 based on the wager received at block 909, in a same or similar manner to that previously described herein with respect to block 320 of FIG. 3A. It is understood that, in some implementations, the credit balance is not updated until a later time (e.g., at the end of the game or the end of the bonus games).

At block 913, the gaming system can determine active pay lines (e.g., wagered pay lines) for the play of the game, in a same or similar manner to that previously described herein. In some implementations, depending on the amount of the wager received at block 909, the gaming system can enable the player to select particular pay lines across reel symbol display areas displayed in a game screen. In some other implementations, the gaming system can select the active pay lines automatically based on the wager received at block 909. It is understood that some implementations of the gaming system may not include pay lines and, as such, the method 900 may not perform block 913. For example, the gaming system may use “Ways-Pays (e.g., All-Ways pays) as an alternative to activating pay lines.

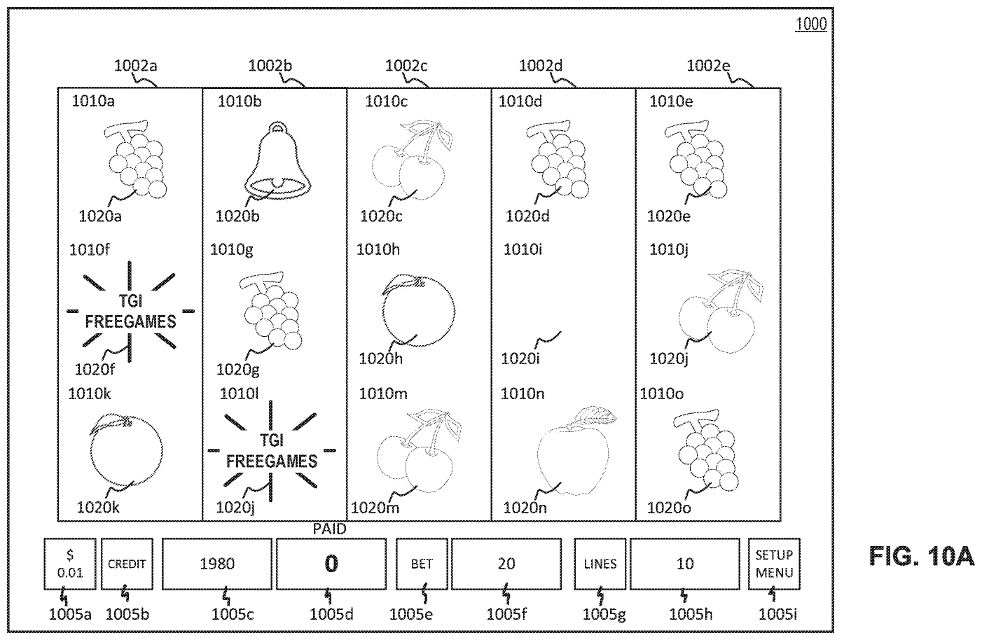

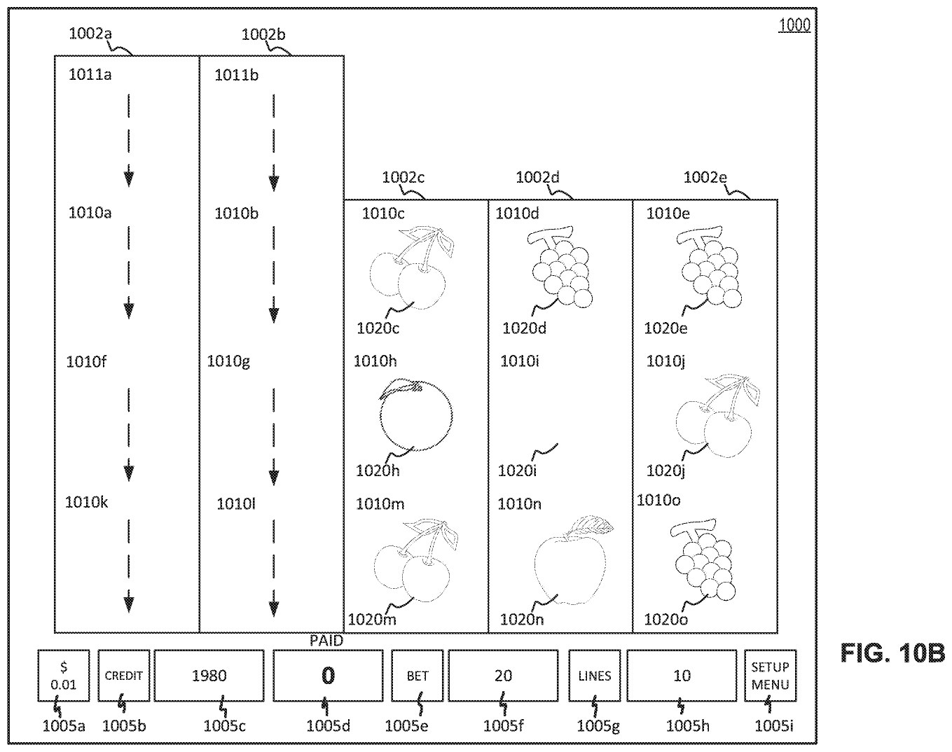

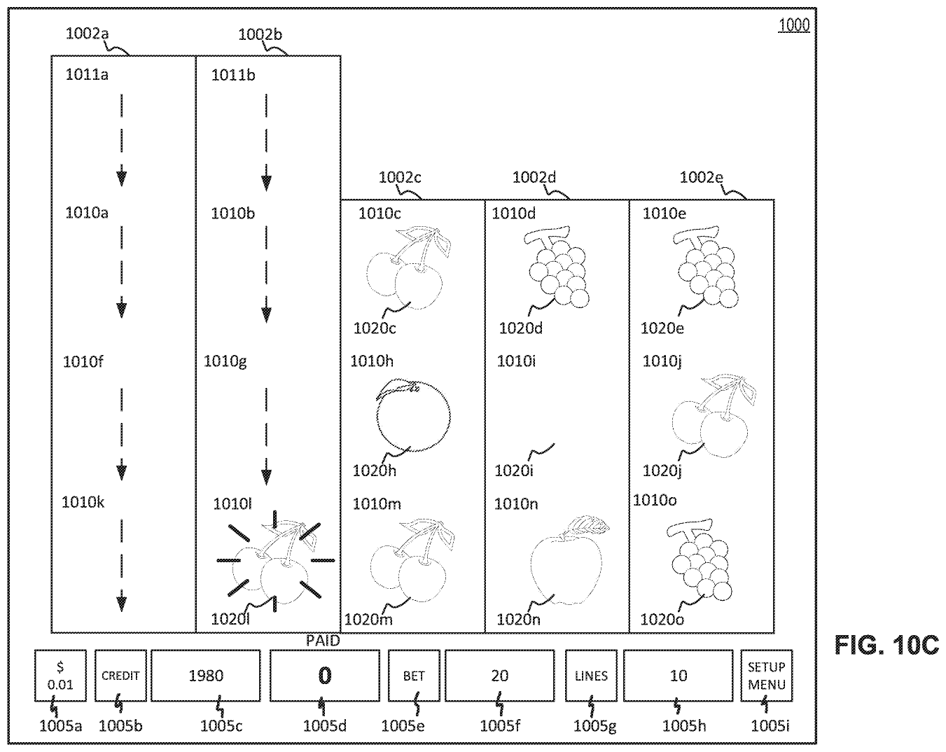

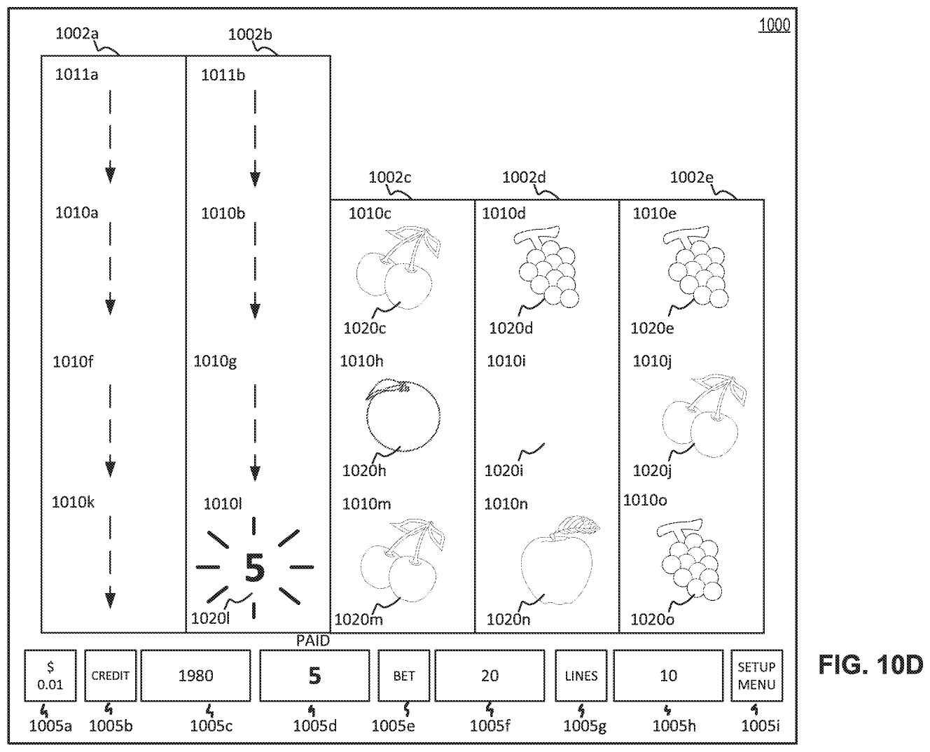

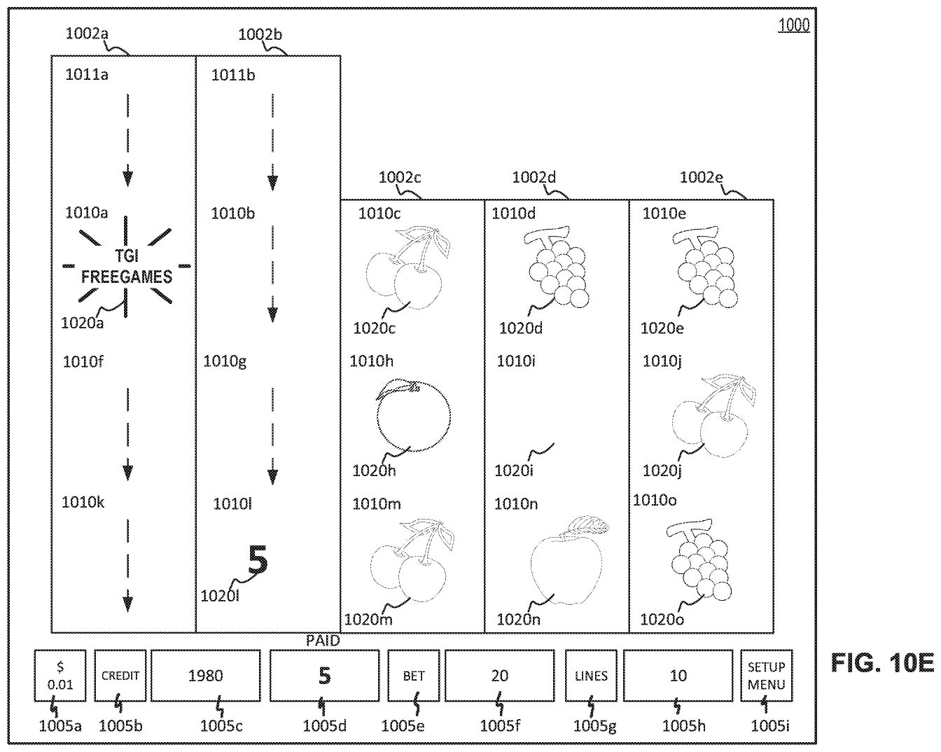

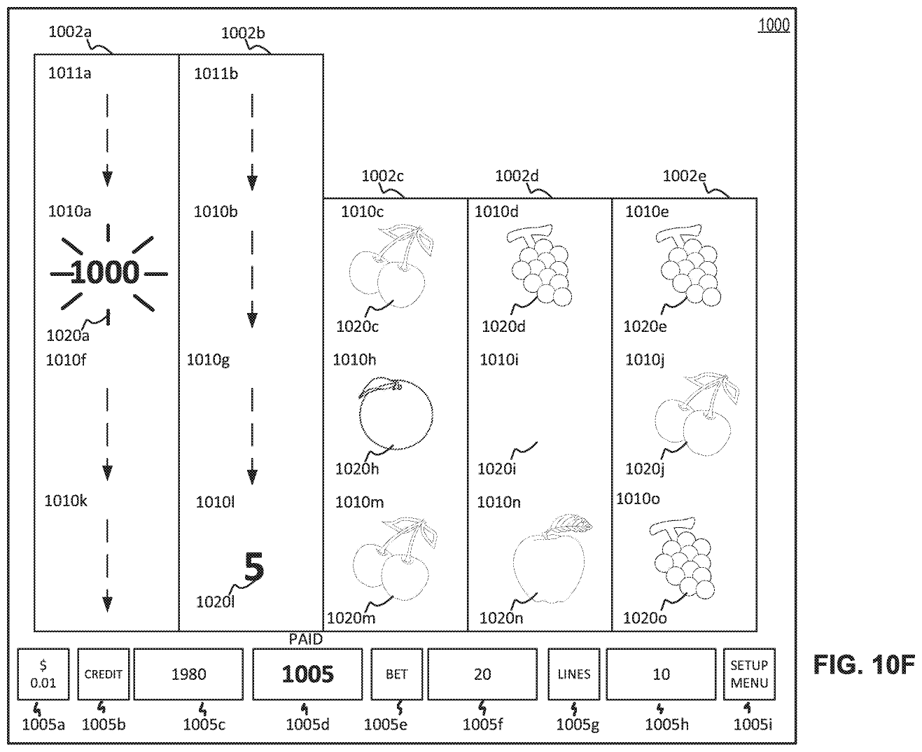

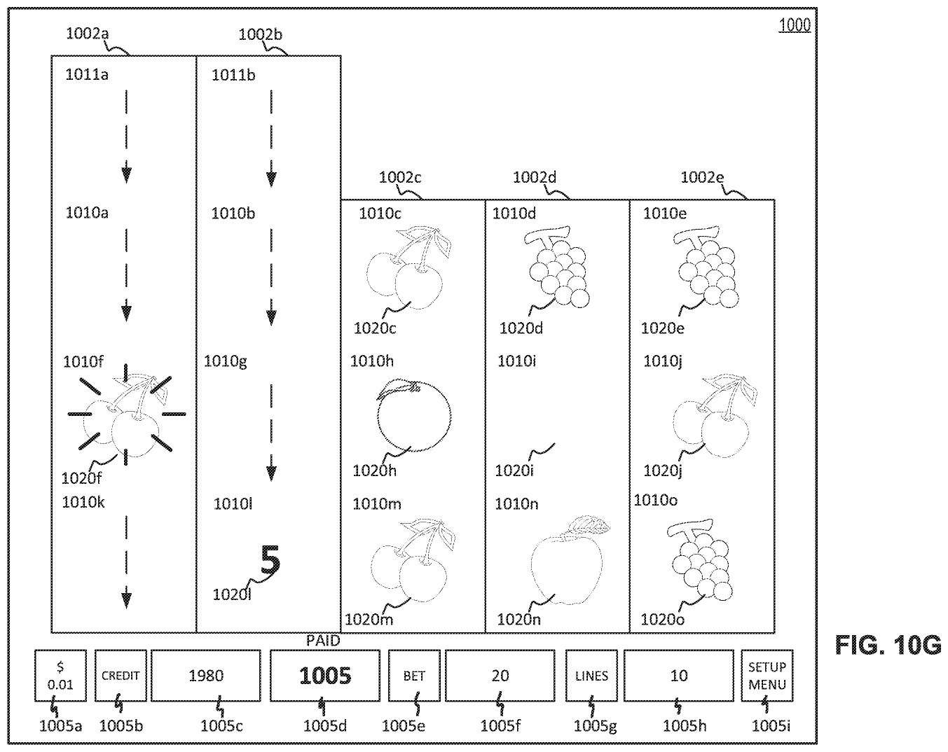

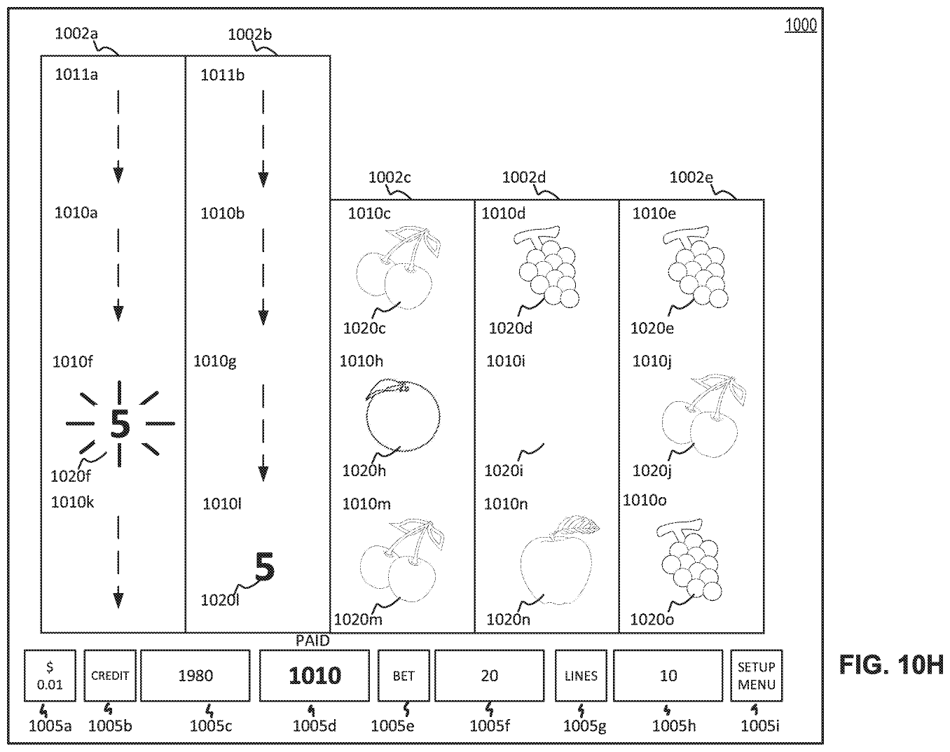

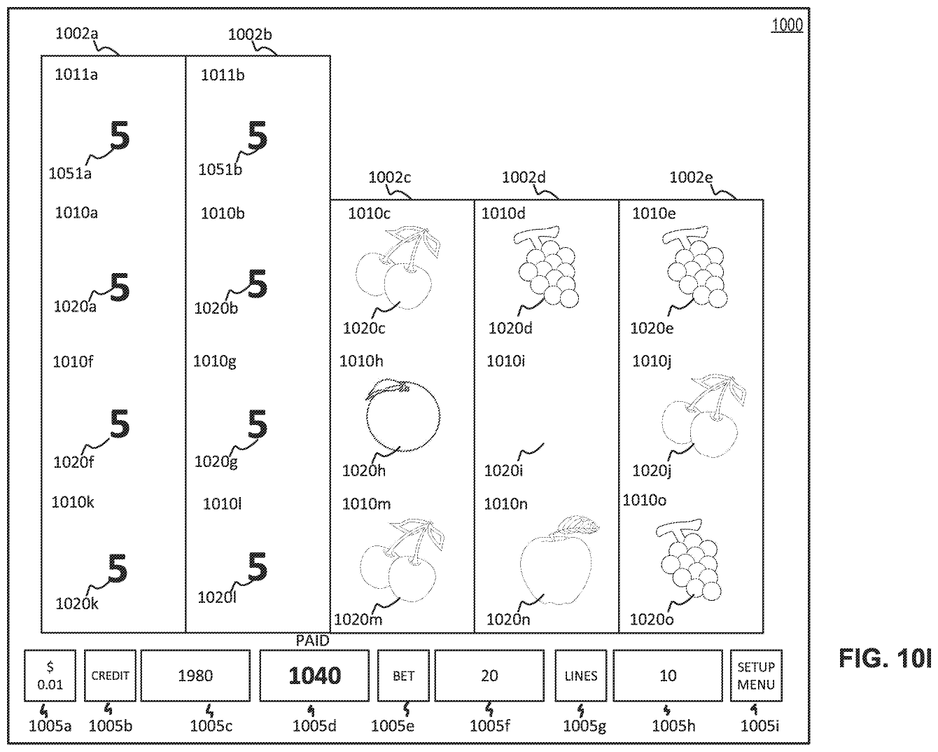

At block 915, the gaming system can initiate the play of a game, in a same or similar manner to that previously described herein. For example, a request to initiate the play of the game may be received from a player via a player input device (e.g., one of input devices 115). For example, the player may press a spin button on the gaming system to start game reels spinning for the play of the game. In implementations, initiating play at block 915 starts the first feature, which may be a base game or a primary game of the gaming system, as previously described herein. At block 917, the gaming system can randomly determine (e.g., using RNG 207) symbols (e.g., symbols 214) for symbol display area (e.g., symbol display areas 1010a-1010o of FIG. 10A) of a game screen (e.g., game screen 1000) presented on a game display device (e.g., game display device 120), in a same or similar manner to that previously described herein with respect to block 330 of FIG. 3A. At block 919, the gaming system can display the symbols determined at block 917 in the symbol display areas using the game display device, in a same or similar manner to that previously described herein with respect to block 335 of FIG. 3A.

Turning now to FIG. 9B, as indicated by off-page connector “A,” at block 921 the gaming system determines winning symbol combinations of the symbols displayed at block 919, in a same or similar manner to that previously described herein with respect to block 340 of FIG. 3B. At block 923, the gaming system determines an award (e.g., payout amount) based on the winning symbol combinations determined at block 921, in a same or similar manner to that previously described herein with respect to block 345 of FIG. 3B. At block 925, the gaming system updates the credit balance determined at block 911 based on the awards determined at block 923 in a same or similar manner to that previously described herein with respect to block 350 of FIG. 3B. As noted above, in some implementations, the credit balance is not updated until a later time (e.g., at the end of the game or the end of a bonus games).

In some implementations, at block 927, the gaming system determines whether an expansion feature of the game has been triggered. In implementations, the trigger of the expansion feature comprises the display of one or more predetermined expansion trigger symbols, which can be the same or similar to the bonus trigger symbols previously described herein. For example, the gaming system may trigger the expansion feature based on determining that the symbols displayed at block 919 include a trigger symbol, a quantity of trigger symbols, a particular sequence of trigger symbols, or some other suitable triggering event. In particular, the gaming system may trigger the expansion feature based on the display of a trigger symbol in an active pay line. In some other implementations, the gaming system randomly triggers the expansion feature based on, for example, an output from a random number generator. In some implementations, the gaming system randomly triggers the expansion feature after occurrence of a threshold number of events (e.g., after wager values in a gaming session exceed a threshold, after a quantity of plays of a game, after a predetermined period of time, etc.).

If at block 927, the gaming system determines that the expansion feature has not been triggered, then the method 900 proceeds to block 931, as detailed below. On the other hand, if at block 927, the gaming system determines that the expansion feature has been triggered, then at block 929, the gaming system expands the symbol display areas of the game screen used at blocks 917 and 919 with one or more additional symbol display areas. For example, in implementations in which the game screen represents a slot machine game having multiple reels, the gaming system can add additional symbol display areas to the one or more of the reels that displayed an expansion trigger symbol. Accordingly, if a first reel that initially included three symbol display area displays an expansion trigger symbol, then the gaming machine may add a fourth symbol display area to the first reel. In some implementations, the quantity of symbol display areas added corresponds to the number of expansion trigger symbols displayed. For example, if the first reel displayed two expansion trigger symbols, then the gaming system may add two symbol display areas to the reel. Additionally, if a second reel displayed a single expansion trigger symbol, then the second reel may add one symbol display area.

At block 931, the gaming system determines whether a bonus game has been triggered. In some implementations, the trigger of the bonus game is a display of one or more predetermined bonus trigger symbols, in a same or similar manner to that previously described herein with respect to block 360 of FIG. 3B. In some of such implementations, the gaming system triggers the bonus game based on determining that the symbols displayed at block 919 include a trigger symbol, a quantity of trigger symbols, a particular sequence of trigger symbols, or some other suitable triggering event. For example, the gaming system may trigger the bonus game if a trigger symbol is displayed in an active pay line. In some other implementations, the gaming system randomly triggers the bonus game based on, for example, an output from a random number generator. In some implementations, the gaming system randomly triggers the bonus game after occurrence of a threshold number of events (e.g., after wager values in a gaming session exceed a threshold, after a quantity of plays of a game, after a predetermined period of time, etc.).

If, at block 931, the gaming system determines that the bonus game has not been triggered, the method 900 proceeds to block 933. At block 933, the gaming system determines whether a request to cash out has been received, in a same or similar manner to that previously described herein with respect to block 362 of FIG. 3B. For example, the gaming system may receive a signal from an input device (e.g., one of the input devices 115 in the player interaction area 112) to end game play or “cash out.” In such a situation, at block 935, the gaming system dispenses a value to the player, through a value dispenser (e.g., value dispenser 222) based on the player's gaming credit balance updated at block 925 in a same or similar manner to that previously described herein with respect to block 364 of FIG. 3B and the method 900 ends. On the other hand, at block 933, if the gaming system has not received a request to end game play, the method 900 returns to block 909 via off-page connector “D,” at which the gaming system may receive a wager for another play of the game and continue the method 900 in a same or similar manner to that previously described herein with respect to block 362 of FIG. 3B. It is understood, however, that the method 900 may not continue if the player has fewer credits than the selected wager amount as shown in block 909.

Returning now to block 931, if the gaming system determines that the bonus game has been triggered, then the method 900 proceeds to block 941 in FIG. 9C via off-page connector “C.” At block 941, the gaming system may receive a request to initiate a play of the bonus game, in a same or similar manner to that previously described herein with respect to block 366 of FIG. 3C. As noted above, the features discussed in connection FIG. 9C may also be applied to primary games or games that are not bonus games. The request to initiate the play of the bonus game may be received from a player via a player input device (e.g., one of input devices 115). For example, the player may press a spin button on the gaming system to start randomly generating symbols for the play of the bonus game. In an alternative implementation, the gaming system may automatically initiate the play of the bonus game and randomly generate symbols for the play of the game.

At block 943, the gaming system determines one or more unlocked symbol display areas from among the symbol display areas of the game screen. In accordance with some implementations of the present disclosure, the unlocked symbol display areas determined at block 943 include the symbol display areas added at block 929. In some implementations, the unlocked symbol display areas determined at block 943 are randomly determined (e.g., using RNG 207). In other implementations, the gaming system determines that unlocked symbol display areas based on the locations of the one or more bonus game trigger symbols determined at block 931. For example, where the bonus game is a slot machine game feature including multiple reels, the gaming system may select all symbol display areas included in reels that include the one or more bonus game trigger symbols at block 931.

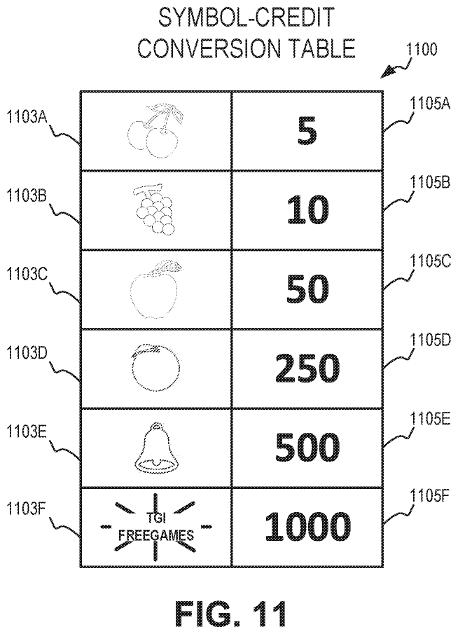

At block 945, the gaming system can determine a lock symbol from among sets of symbols corresponding to the unlock symbol display areas determined at block 943. In some implementations, the lock symbol can be a predetermined symbol. Similar to some examples previously described herein, the lock symbol can be a symbol having a lowest monetary value (e.g., credit symbol 1105A) among the sets of symbols. Referring to table 1100 in FIG. 11 for example, the gaming system can determine the lock symbol to be the cherry symbol 1103A corresponding to the lowest value credit symbol 1105A (“5”) among the set of credit symbols 1105A-1105E. In other implementations, the gaming system can randomly select (e.g., using the RNG 207) one symbol from among the set of symbols 1103A-1103F to be the lock symbol

At block 947, the gaming system randomly determines (e.g., using RNG 207) one or more symbols for one or more of the unlocked symbol display areas determined at block 943 in a same or similar manner to that previously described with regard to block 368 of FIG. 3C. In some implementation, the gaming system generates the one or more symbols from the symbol sets corresponding to the unlocked symbol display areas. In other implementations, the individual reels containing the unlocked symbol display areas are associated with respective symbol sets, wherein each of the symbol sets may be the same or different.

In some implementations, the game system iteratively determines the symbols at block 947 one symbol at a time over multiple cycles (e.g., rounds) of the bonus game, in which, for example, a single cycle can include blocks 947-961. It is understood that in some other implementations, the gaming system can determine more than one symbol per cycle of the bonus game. Additionally, in some implementations, the gaming system can randomly select (e.g., using RNG 207) the one or more unlocked symbol display area for which the symbols are determined in an individual cycle of the bonus game from among the unlocked symbol display areas determined at block 943. In other implementations, the gaming system can select the one or more unlocked symbol display area for which the symbols are determined in an individual cycle in a predetermined order or sequence (such as previously described herein with regard to FIGS. 4A-4I).

At block 949, the gaming system displays (e.g., using game display device 120) the one or more symbols determined at block 947 in their corresponding symbol display areas, in a same or similar manner to that previously described herein with respect to block 370 of FIG. 3C. The gaming system may display the one or more symbols (from the bonus symbol set) in the unlocked symbol display areas selected or determined in block 947. In some implementations, the gaming system iteratively displays the symbols determined at block 947 in the corresponding unlocked symbol display areas one symbol at a time over the multiple cycles (e.g., rounds or trials) of the bonus game.

At block 951, the gaming system can convert the one or more symbols displayed at block 949 to credit symbols. In some implementations, converting the symbols to credit symbols uses a predetermined mapping between symbols and credit symbols to replace the one or more symbols displayed at block 949 with the corresponding one or more credit symbols. For example, FIG. 11 illustrates a table 1100 that maps symbols 1103A-1103F to credit symbols 1105A-1105F. The gaming system can reference the table 1100 to determine the correspondence used to convert the individual symbols displayed at block 949 to their respective credit symbols displayed at block 951.

At block 953, the gaming system determines the values of the credit symbols displayed in the unlocked symbol display areas at block 951, in a same or similar manner to that previously described herein with respect to block 372 of FIG. 3C. At block 955, the gaming system may update the credit balance determined at block 925 in accordance with any obtained award determined at block 953. As noted above, it is understood that the gaming system may update the credit balance at other suitable times.

Turning to FIG. 9D, as indicated by off-page connector “E,” at block 957 the gaming system determines whether the credit symbols displayed at block 951 include the lock symbol determined at block 947. If the credit symbols do not include the lock symbol (e.g., block 957 is “No”) then the method 900 proceeds to block 961 as discussed below. On the other hand, if the credit symbols include the lock symbol (e.g., block 957 is “Yes”), then the gaming system locks the one or more symbol display areas including the lock symbol, in a same or similar manner to that previously described herein with respect to block 374 of FIG. 3C.

At block 961, the gaming system determines whether the bonus game initiated at block 941 is complete. In some implementations, the gaming system determines that the bonus game is complete when no additional unlocked symbol display areas remain in the unlocked reels, such as previously described herein with respect to block 378 of FIG. 3C. If the gaming system determines that the bonus game is complete (e.g., if no unlocked symbol display areas remain block 961), then the method 900 proceed via off page connector B to block 933 in FIG. 9B. On the other hand, if the gaming system determines that the bonus game is incomplete (e.g., unlocked symbol display areas remain), then the method 900 iteratively returns to block 949 to continue with the play of the bonus game, as indicated by off-page connector “F.” That is, the gaming system may execute another cycle (e.g., round, trial, attempt, spin, or play) of the bonus game in blocks 949-961 until, at block 961, the gaming system determines that the bonus game is complete where executing blocks 949-961 once comprises one cycle.

In some implementations, the gaming system may also determine that the bonus game is complete at block 961 based on a number of cycles included in the bonus game. The number of cycles can be a predetermined quantity (e.g., 5 or some other suitable amount) or randomly determined from a predetermined range (e.g., selected from a range of 5-10 cycles). Additionally, the number of cycles can be determined based on the symbols displayed at block 919 of the base game feature. For example, a special symbol appearing on one or more reels may award additional cycles of the bonus game. In implementations limiting the number of cycles, the method 900 may not determine the lock symbol at block 947 or evaluate the displayed credit symbol to identify the lock symbol at block 957. In some alternative implementations, the lock symbol is used after the quantity of cycles are completed. For example, if the quantity of cycles is five, then the lock symbol may not be used during the first five cycles for each originally unlocked symbol display area but can be used to stop the bonus game after the first five cycles by locking down the unlocked symbol display areas. In some implementations, the bonus game can be stopped without lock symbols because of the limited quantity of available cycles.

FIGS. 10A-10I illustrate screen shots of a game screen 1000 provided by an example implementation of a gaming system in accordance with aspects of the present disclosure. For the sake of brevity, FIG. 10A represents a screen shot of a base game (a.k.a., a primary game), which may operate in a same or similar manner the base game discussed previously herein with regard to FIGS. 4A and 4B. In is understood that the base game can be a different type of game than is illustrated in FIG. 4A, 4B, or 10A.

In FIG. 10A, the gaming system (e.g., using processor 202 of game controller 200 executing program instructions of the game module 205) displays the symbols 1020a-1020o (e.g., symbols 214) in symbol display areas 1010a-1010o of the game screen 1000. In the present example, the symbol display areas 1010a-1010o are provided within reels 1002a-1002e representing a five-reel slot machine game, wherein each of the reels 1002a-1002e include three of the symbol display areas 1010a-1010o so as to provide the game screen 1000 as a 3-by-5 array. It is understood that the game screen 1000 can have other configurations having greater or fewer numbers of the symbol display areas 1010a-1010o (e.g., a 5-by-5 array or a 3-by-3 array).

The gaming system randomly determines and displays the symbols 1020a-1020o in the symbol display areas 1010a-1010o of reels 1002a-1002e (such as previously described with regard to FIG. 9A, blocks 917 and 919). In some implementations, the gaming system spins the reels 1002a-1002e and displays the symbols 1020a-1020o after the reels 1002a-1002e have stopped spinning in the primary game.

FIG. 10A further illustrates the gaming system evaluating the symbols 1020a-1020o displayed in the reels 1002a-1002e (such as previously described with regard to FIG. 9B, blocks 921 and 923). As noted above, the player may have placed a wager that activates one or more pay lines, such as the 10 pay lines shown in information area 1005h (such as previously described herein with regard to FIG. 9A, block 913). In some implementations, at least the active paylines (e.g., wagered-on pay lines) are evaluated for predetermined winning symbol combinations (such as previously described herein with regard to FIG. 9B, block 921). In the example illustrated in FIG. 10A, no winning symbol combinations were displayed across any active pay lines. As such, the evaluation of the symbols 1020a-1020o, the gaming system may determine that the symbols do not include winning symbols or winning symbol combinations and the gaming system does not increase the player's credits or the value indicated by the credit meter 1005d.

Additionally, the gaming system may evaluate the symbols 1020a-1020o displayed on the reels 1002a-1002e to identify expansion triggering symbols and bonus triggering symbols (such as previously described with regard to FIG. 9B, blocks 927 and 931). In the present example, the “TGI Freegames” symbol functions as both the expansion triggering symbol and the bonus triggering symbol. It is understood that the expansion triggering symbol and the bonus triggering symbol may be different symbols. It is also understood that the symbols sets may include more than one type of the expansion triggering symbol and more than one type of bonus triggering symbol. For example, a first type of expansion triggering symbol may provide one additional symbol display area, and another type of expansion triggering symbol may provide more than one (e.g., 2) additional symbol areas. Also, for example, a first type of bonus game triggering symbol may activate one of the reels 1002a-1002e for the bonus game, and another type of bonus game triggering symbol may activate more than one (e.g., 2) of the reels 1002a-1002e for the bonus game.

As illustrated in FIG. 10A, symbol display areas 1010f and 1010j of reels 1010a and 1010b respectively display the TGI Freegames symbols 1020f and 1020j. The TGI Freegames symbols 1020f and 1020j can trigger expansion of the reels 1002a and 1002 and initiate a bonus game (such as previously described with regard to FIG. 9B, blocks 927 and 931). Further, in some implementations, the gaming system can highlight the TGI Freegames symbols to indicate the triggering of the expansion feature or bonus game.

Turning to FIG. 10B, because the gaming system displayed expansion trigger symbols (i.e., TGI Freegames symbols 1020f and 1020j in the present example) in reels 1002a and 1002b, such event can trigger the gaming system to expand the reels 1002a and 1002b by adding symbol display areas 1011a and 1011b respectively to the reels 1002a and 1002b (such as previously described herein with regard to FIG. 9B, block 929). As illustrated in FIG. 10B, the gaming system can add single symbol display areas 1011a and 1011b to the reels 1002a and 1002b corresponding to the single TGI Freegames symbols 1020f and 1020j respective displayed in the reels 1002a and 1002b. It is understood that, in some implementations, the TGI Freegames symbols 1020f and 1020j could add more than one symbol display area to the reels. For example, the gaming system may add two symbol display areas per TGI Freegames symbol above the reels 1002a and 1002b. It is also understood that, in some implementations, the TGI Freegames symbols 1020f and 1020j may add symbol display areas to other positions of the reels. For example, in some implementations, the gaming system may respectively provide an additional symbol display area below the symbol display areas 1010k and 1010l. And, in some implementations, the gaming system may respectively provide additional symbol display areas above 1010a and 1010b, and below the symbol display areas 1010K and 1010l. Further, it is understood that, in some implementations, the additional symbol display areas may be added to the reels 1002a-1002e other than those in which the TGI Freegames symbols 1020f and 1020j were displayed. For example, the gaming system can randomly select one of the reels 1002a-1002e for expansion in response to a TGI Freegames symbol being displayed in one of the reels 1002a-1002e. In some implementations, the gaming system may add additional symbol display areas to the reels based on other events independent of displayed TGI Freegames symbols or independent of the quantity of TGI Freegames symbols generated. In some implementations, in response to entering the bonus game, the gaming system may randomly select one or more reels to add symbol display areas to and/or may randomly select the quantity of additional symbol display areas that one or more reels will obtain.

Still referring to FIG. 10B, because the gaming system displayed two bonus triggering symbols (i.e., the TGI Freegames symbol 1020f and 1020j in the present example), the gaming system may also trigger the bonus game (such as previously discussed with regard to block 931 of FIG. 4B). The gaming system can initiate a play of the bonus game (such as previously described with regard to block 941 of FIG. 9C) and can determine unlocked symbol display areas corresponding to the reels 1002a and 1002b (such as previously described with regard to block 943). In some implementations, other of the reels 1002a-1002e can be unlocked for the bonus game. For example, reels 1002a, 1002b, and 1002c may be unlocked in some implementations. As another example, reels 1002a, 1002b, and 1002d may be unlocked. In the present example, the reels 1002c, 1002d, and 1002e did not display TGI Freegames symbols. As such, the symbol display areas of the reels 1002c, 1002d, and 1002e are not unlocked for the bonus game and the gaming system does not generate symbols in the bonus game for the symbol display areas of the reels 1002c, 1002d, and 1002e in FIGS. 10A-10I.

In some implementations, the gaming system associates different bonus symbol sets with each of the unlocked symbols display areas 1010a, 1010f, 1010k, 1010b, 1010g, and 1010l. Thus, the gaming system may generate (e.g., using the RNG), symbols for the symbol display areas 1010a, 1010f, 1010k, 1010b, 1010g, and 1010l from their respective symbol sets for the bonus game. In other implementations, the gaming system associates different bonus symbol sets with each of the unlocked reels 1002a and 1002b. Thus, the gaming system may generate symbols for the symbol display areas 1010a, 1010f, 1010k, 1010b, 1010g, and 1010l in reels 1002a and 1002b from two different bonus symbol sets (e.g., different reel strips). It should be appreciated that the compositions of the symbols in the symbol sets and the quantity of symbols sets may vary similar to the variations previously discussed with regard to FIGS. 4A-4I.

Still referring to FIG. 10B, the gaming system can determine and display symbols for the unlocked symbol display areas 1010a, 1010f, 1010k, 1010b, 1010g, and 1010l, 1011a, and 1011b of the reels 1002a and 1002b (such as previously described with regard to blocks 947 and 949 of FIG. 9C). As illustrated in FIGS. 10B-10I and as previously described herein with regard with regard to blocks 947 and 949, in some implementations, the gaming system can iteratively determine symbols for the unlocked symbol display areas 1010a, 1010f, 1010k, 1010b, 1010g, and 1010l, 1011a one at a time over multiple cycles of the bonus game. In some implementations, the gaming system cycles or spins the symbol display areas 1010a, 1010f, 1010k, 1010b, 1010g, and 1010l, 1011a, and 1011b prior to displaying a determined symbol. The cycling or spinning symbols may appear like individual reels in each of symbol display areas 1010a, 1010f, 1010k, 1010b, 1010g, 1010l, 1011a, and 1011b. In the present example, the directional arrows illustrated in FIG. 10B indicate the direction of the cycling or spinning. However, it is understood that any suitable direction may be used. For example, each of the symbol display areas can 1010a, 1010f, 1010k, 1010b, 1010g, and 1010l, 1011a, and 1011b cycle or spin through symbols in different directions. The gaming system may the generate symbols from the bonus symbol sets corresponding respectively to the symbol display areas 1010a, 1010f, 1010k, 1010b, 1010g, and 1010l, 1011a, and 1011b. In some other implementations, the gaming system generates a symbol from a bonus symbol set as the gaming system is ready to display the generated symbols in particular ones of the symbol display areas 1010a, 1010f, 1010k, 1010b, 1010g, and 1010l, 1011a, and 1011b.

Turning to FIG. 10C, the gaming system selected one or more of the unlocked symbol display areas 1010a, 1010f, 1010k, 1010b, 1010g, 1010l, 1011a, and 1011b of the reels 1002a and 1002B to display a bonus symbol randomly determined one or more symbols corresponding to the selected symbol display areas (e.g., as previously described with regard to blocks 947 and 949 of FIG. 9C). In some implementations, the gaming system can select the unlocked symbol display areas in a predetermined order. For example, the gaming system can determine the symbols for the symbol display areas 1010a, 1010f, 1010k, 1010b, 1010g, and 1010l, 1011a, and 1011b in a sequential order or a cascading order, as previously described herein. In other implementations, the gaming system can randomly select one or more of the unlocked symbol display areas 1010a, 1010f, 1010k, 1010b, 1010g, 1010l, 1011a, and 1011b to display a bonus symbol.

In the present example, the gaming system may select unlocked symbol display area 1010l, randomly determine a “Cherry” from a set of symbols corresponding to symbol display area 1010l, and display the “Cherry” as symbol 1020l in the symbol display area 1010l. In accordance with some implementations, the selection of selection unlocked symbol display area 1010l and the display of the “Cherry” symbol 1020l can represent first selection and determination of a first cycle of the bonus game. In addition to displaying the “Cherry” symbol 1020l in symbol display area 1010l, the gaming system may also provide an indication (e.g., flashing, highlighting, blinking or the like) in symbol display area 1010l signaling the selection of symbol display area 1010l or the display of symbol 1020l in symbol display area 1010l.

In FIG. 10D, the gaming system converts the “Cherry” displayed in symbol display area 1010l of FIG. 10C to a “5” credit symbol 1020l, which represents a monetary value (e.g., as previously described with regard to block 951 of FIG. 9C). In some implementations, the gaming system converts the “Cherry” symbol to the “5” credit symbol 1020l based on a predetermined mapping (e.g., table 1100 in FIG. 11). Based on the conversion, the gaming system can determine an award corresponding to the “5” credit symbol 1020l and update a credit balance based on such determination (e.g., as previously described with regard to blocks 953 and 955 of FIG. 9C). For example, as shown in the information display area 1005d, the gaming system determines that the “5” credit symbol is displayed in the symbol display area 1011a and update the credit meter 1005d to reflect a 5 credit award corresponding to the “5” symbol.

The gaming system can also determine whether the “5” credit symbol 1020l is a lock symbol (such as previously described in block 957 of FIG. 9D). As previously detailed herein, when the gaming system provides a lock symbol in an unlocked symbol display area of the bonus game, the gaming system locks the corresponding symbol display area from additional selection and determination of symbols for the remainder of the bonus game. In some implementations, the lock symbol is predetermined. For example, with reference to the credit symbols “5,” “10,” “50,” “250,” “500,” and “1000” (e.g., as shown in FIG. 11), the lock predetermined lock symbol may be the lowest value symbol in the bonus symbol set (e.g., the “5” symbol in FIG. 11). In other implementations, the lock symbol is designated as the highest value symbol in the bonus symbol set (e.g., the “1000” symbol from FIG. 11). It is understood that any suitable symbol from the bonus symbol sets can be designated as the lock symbol. For example, in some implementations, the gaming system may randomly select one of the credit symbols in the bonus symbol set to be the lock symbol. The gaming machine may indicate the selected lock symbol by highlighting it in the game screen or by using some other suitable indicator (e.g., font type, font color, background color, flashing, or the like). In the present example, the selected lock symbol is the “5” credit symbol. Accordingly, the gaming system locks the “5” credit symbol 1020l in symbol display area 1010l for the remainder of the play of the bonus game (such as previously described with regard to blocks 957 and 959 of FIG. 9D).

In FIG. 10E, the gaming system again selects one or more of the unlocked symbol display areas 1010a, 1010f, 1010k, 1010b, 1010g, 1010l, 1011a, and 1011b of the reels 1002a and 1002B to display a bonus symbol and randomly determines one or more symbols corresponding to the selected symbol display areas (e.g., as previously described with regard to blocks 947 and 949 of FIG. 9C). In the present example, the gaming system randomly generates and displays a “TGI Freegames” in symbol display area 1010a. In accordance with some implementations, the selection of unlocked symbol display area 1010a and the display of the “TGI Freegames” symbol 1020a can represent selection and determination of a second cycle of the bonus game. In addition to displaying the “TGI Freegames” 1020a, the gaming system may also provide an indication in symbol display area 1010a indicating the selection of symbol display area 1010a or the display of symbol 1020a.

Further, as previously described with regard to FIG. 10D, and as illustrated in FIG. 10F, the gaming system converts the “TGI Freegames” to a “1000” credit symbol 1020a representing a monetary value. Based on the conversion, the gaming system can determine an award corresponding to the “1000” credit symbol 1020a and update a credit balance based on such determination. For example, as shown in the information display area 1005d, the gaming system determines that the “1000” credit symbol is displayed in the symbol display area 1011a and update the credit meter 1005d to reflect 1005 credit award, including the previous 5 credit award. Still further, the gaming system can also determine whether the “1000” credit symbol 1020a is a lock symbol. In the present example, the “5” credit symbol is the lock symbol. Accordingly, the gaming system does not lock symbol display area 1011a of FIG. 10E (such as previously described with regard to block 957, “No” of FIG. 9D). By comparison, the “5” credit symbol of FIG. 10D is a lock symbol and, therefore, remains displayed for the remainder of the game, including in FIGS. 10E and 10F.

Turning to FIG. 10G, the gaming system again selects one or more of the unlocked symbol display areas 1010a, 1010f, 1010k, 1010b, 1010g, 1010l, 1011a, and 1011b of the reels 1002a and 1002B to display a bonus symbol and randomly determines one or more symbols corresponding to the selected symbol display areas (e.g., as previously described with regard to blocks 947 and 949 of FIG. 9C). In the present example, the gaming system of the present example may select unlocked symbol display area 1010f, randomly determine a “Cherry” from a set of symbols corresponding to symbol display area 1010f, and display the “Cherry” as symbol 1020f in the symbol display area 1010f. In accordance with some implementations, the selection of selection unlocked symbol display area 1010f and the display of the “Cherry” symbol 1020f can represent selection and determination of a third cycle of the bonus game.

As before, the gaming system may also provide an indication in symbol display area 1010f signaling the selection of symbol display area 1010f or the display of symbol 1020f in symbol display area 1010lf. In FIG. 10H, the gaming system converts the “Cherry” to a “5” credit symbol 1020f representing a monetary value (e.g., as previously described with regard to block 951 of FIG. 9C). Additionally, the gaming system can determine an award corresponding to the “5” credit symbol 1020f and update the credit meter 1005d to reflect a 5 credit award corresponding to the “5” symbol. Further, the gaming system can also determine that the “5” credit symbol 1020l is a lock symbol (such as previously described in block 957 of FIG. 9D). Accordingly, the gaming system locks the “5” credit symbol 1020f in symbol display area 1010f for the remainder of the play of the bonus game.

FIG. 10I illustrates an example of the game screen 100 after multiple cycles of generating, displaying, converting, evaluating, and locking bonus symbols in the bonus game initiated in FIG. 10B. In FIG. 10I all the symbol display areas 1010a, 1010f, 1010k, 1010b, 1010g, 1010l, 1011a, and 1011b that were unlocked for the bonus game in FIG. 10B are occupied by the lock symbol. Thus, in the example illustrated in FIG. 10I, no unlocked symbol display areas remain. The gaming system, therefore, does not generate additional symbols for the symbol display areas from the bonus symbol set. The play of the bonus game ends (such as previously described with regard to block 961 of FIG. 9D).

Based on the forgoing description, it should be appreciated that a gaming system and method with a repeating free spin win accumulator creates new and very exciting ways for a player to obtain winning symbols with a potential to earn frequent and greater awards. The gaming system increases volatility and excitement for players in implementations where award amounts are not predetermined, activations of the repeating free spin win accumulator are frequent, and there are no losing outcomes. Such a potential to earn greater awards creates a greatly improved sense of anticipation for players.

In some implementations, the features described herein technologically improves the gaming system by performing selective evaluations of displayed symbols. For example, when evaluating the determined symbols for some implementations of the above-described bonus game, the gaming system may limit its evaluation of displayed symbols for displayed symbols within selected, unlocked symbol display areas (e.g., symbol display areas 1010a, 1010f, 1010k, 1010b, 1010g, and 1010l, 1011a, and 1011b in FIG. 10B), rather than evaluating all symbols in a game screen in its evaluation. By limiting its evaluation of displayed symbols within selected, unlock symbol display areas, the gaming system reduces the quantity of symbols it evaluates, enabling the gaming systems to complete a play of a game more quickly than systems that evaluate all of the displayed symbols. By doing so, in some implementations, the disclosed gaming systems can increase the usage rate of the gaming system by allowing more games to be completed in a given time period (e.g., games per hour) and by reducing power consumed during one or more plays of a game.

Moreover, in some implementations, reducing the quantity of displayed symbols that are evaluated for the bonus game also reduces the processing load and memory consumption of the gaming system. By doing so, implementations of the disclosed gaming system avoid reading and writing certain symbols from memory, which increases the efficiency of the gaming system by conserving processor loading and reduces memory consumption. And, when such efficiency improvements are made and applied to the hundreds or thousands of game evaluations in multiple installations of the gaming system (e.g., multiple devices installed at a casino), implementations of the disclosed gaming system provide casino game operators sizable gains in machine efficiency, which is a technological improvement. It should be appreciated that in some implementations with the technological improvement, the gaming system may still evaluate symbols outside of a unlocked symbol display areas for other types winning symbols or winning symbol combinations discussed above.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a processor and a memory device storing program instructions that, when executed by the processor, cause the gaming system to:
receive a wager for a game using a credit balance established for the gaming system;
initiate a play of the game;
randomly determine symbols for symbol display areas of a game screen;
display, using a display device, the symbols in the symbol display areas;
determine that the symbols trigger a bonus feature;
select, in response to the trigger of the bonus feature, a plurality of the symbol display areas;
randomly determine one or more credit symbols for one or more symbol display areas of the plurality of the symbol display areas;
display, using the display device, the one or more credit symbols in the one or more symbol display areas of the plurality of the symbol display areas;
determine an award based on the one or more credit symbols;
update the credit balance based on the award;
determine whether to continue the bonus feature based on the one or more credit symbols; and
issue a value based on the credit balance in response to a cash out request.

2. The gaming system of claim 1, wherein:
randomly determining the one or more credit symbols for the one or more symbol display areas of the plurality of the symbol display areas:
randomly selecting a first symbol for a first symbol display area of the plurality of the symbol display areas from a first set of symbols corresponding to the first symbol display area; and
converting the first symbol to a first credit symbol corresponding to a respective monetary award; and
displaying the one or more credit symbols in the one or more symbol display areas of the plurality of the symbol display areas comprises:
displaying the first symbol in the first symbol display area of the plurality of the symbol display areas; and
displaying the first symbol converted to the credit symbol in the first symbol display area of the plurality of the symbol display areas.

3. The gaming system of claim 2, wherein:
the plurality of the symbol display areas comprises a plurality of unlocked symbol display areas corresponding to one or more sets of symbols;
the one or more sets of symbols include a plurality of lock symbols, and
for the plurality of unlocked symbol display areas, the program instructions further cause the gaming system to:
determine that the first symbol display area displays a first lock symbol of the plurality of lock symbols; and
lock the first symbol display area based on the first lock symbol.

4. The gaming system of claim 3, wherein, for symbol display areas of the plurality of unlocked symbol display areas that remain unlocked after locking the first symbol display area, the program instructions continue to cause the gaming system to:
randomly determine additional symbols from the one or more sets of symbols;
display the additional symbols in the plurality of unlocked symbol display areas that remain unlocked;
convert the additional symbols to additional credit symbols;
determine additional awards based on the additional credit symbols;
update the credit balance based on the additional awards; and
lock unlocked symbol display areas of the plurality of unlocked symbol display areas in response to the lock symbol being generated and displayed.

5. The gaming system of claim 3, wherein the program instructions further cause the gaming system to randomly select the lock symbol.

6. The gaming system of claim 1, wherein the program instructions further cause the gaming system to:
determine that the displayed symbols trigger an expansion feature of the game; and
add, in response to the trigger of the expansion feature, one or more symbol display areas to the game screen.

7. The gaming system of claim 6, wherein:
the symbol display areas of the game screen represent a plurality of reels;
the plurality of the symbol display areas comprise a first reel of the plurality of reels; and
adding the one or more symbol display areas comprises expanding the first reel with a quantity of additional symbol display areas based on the trigger of the expansion feature.

8. The gaming system of claim 7, wherein:
determining that the displayed symbols trigger the expansion feature of the game comprises determining that the symbol display areas of the first reel include one or more expansion trigger symbols;
expanding the first reel comprises:
determining a quantity of the one or more expansion trigger symbols in the first reel; and
adding the quantity additional symbol display areas corresponding the quantity of the one or more expansion trigger symbols in the first reel.

9. The gaming system of claim 1, wherein:
the triggering a first feature of the game comprises displaying a predetermined symbol; and
selecting the plurality of the symbol display areas comprises:
in response to one predetermined symbol being displayed, selecting a first quantity of the symbol display areas, and
in response to two predetermined symbols being displayed, selecting a second quantity of the symbol display areas.

10. A method of operating a gaming system comprising:
receiving a wager for a game using a credit balance established for the gaming system;
initiating a play of the game;
randomly determining symbols for symbol display areas of a game screen;
displaying, using a game display device, the symbols in the symbol display areas;
determining that the symbols trigger a bonus feature;
selecting, in response to the trigger of the bonus feature, a plurality of the symbol display areas;
randomly determining one or more credit symbols for one or more symbol display areas of the plurality of the symbol display areas;
displaying, using the game display device, the one or more credit symbols in the one or more symbol display areas of the plurality of the symbol display areas;
determining an award based on the one or more credit symbols;
updating the credit balance based on the award;
determining whether to continue the bonus feature based on the one or more credit symbols; and
issuing a value based on the credit balance in response to a cash out request.

11. The method of claim 10, wherein
randomly determining the one or more credit symbols for the one or more symbol display areas of the plurality of the symbol display areas:
randomly selecting a first symbol for a first symbol display area of the plurality of the symbol display areas from a first set of symbols corresponding to the first symbol display area; and
converting the first symbol to a first credit symbol corresponding to a respective monetary award; and
displaying the one or more credit symbols in the one or more symbol display areas of the plurality of the symbol display areas comprises:
displaying the first symbol in the first symbol display area of the plurality of the symbol display areas; and
displaying the first symbol converted to the credit symbol in the first symbol display area of the plurality of the symbol display areas.

12. The method of claim 11, wherein
the plurality of the symbol display areas comprises a plurality of unlocked symbol display areas corresponding to one or more sets of symbols;
at least one of the one or more sets of symbols include a lock symbol, and
the method further comprises, for the plurality of unlocked symbol display areas:
determining that the first symbol display area displays the lock symbol; and
locking the first symbol display area based on the lock symbol.

13. The method of claim 12, further comprising, for symbol display areas of the plurality of unlocked symbol display areas that remain unlocked after locking the first symbol display area:
randomly determining additional symbols from the one or more sets of symbols;
displaying the additional symbols in the plurality of unlocked symbol display areas that remain unlocked;
converting the additional symbols to additional credit symbols;
determining additional awards based on the additional credit symbols;
updating the credit balance based on the additional awards; and
locking unlocked symbol display areas of the plurality of unlocked symbol display areas in response to the lock symbol being generated and displayed.

14. The method of claim 12 further comprising randomly selecting the lock symbol.

15. The method of claim 10 further comprising:
determining that the displayed symbols trigger an expansion feature of the game; and
adding, in response to the trigger of the expansion feature, one or more symbol display areas to the game screen.

16. The method of claim 15, wherein:
the symbol display areas of the game screen represent a plurality of reels;
the plurality of the symbol display areas comprise a first reel of the plurality of reels; and
adding the one or more symbol display areas comprises expanding the first reel with a quantity of additional symbol display areas based on the trigger of the expansion feature.

17. The method of claim 16, wherein:
determining that the displayed symbols trigger the expansion feature of the game comprises determining that the symbol display areas of the first reel include one or more expansion trigger symbols;
expanding the first reel comprises:
determining a quantity of the one or more expansion trigger symbols in the first reel; and
adding the quantity additional symbol display areas corresponding the quantity of the one or more expansion trigger symbols in the first reel.

18. The method of claim 10, wherein:
the trigger of the bonus feature comprises a predetermined symbol; and
selecting the plurality of the symbol display areas comprises:
in response to one predetermined symbol being displayed, selecting a first quantity of the symbol display areas, and
in response to two predetermined symbols being displayed, selecting a second quantity of the symbol display areas.

19. A non-transitory computer-readable storage device having program instructions stored thereon, the program instructions being executable by a processor to cause a gaming system to:
receive a wager for a game using a credit balance established for the gaming system;
initiate a play of the game;
randomly determine symbols for symbol display areas of a game screen;
display, using a game display device, the symbols in the symbol display areas;
determine that the symbols trigger a bonus feature;
select, in response to the trigger of the bonus feature, a plurality of the symbol display areas;
randomly determine one or more credit symbols for one or more symbol display areas of the plurality of the symbol display areas;
display, using the game display device, the one or more credit symbols in the one or more symbol display areas of the plurality of the symbol display areas;
determine an award based on the one or more credit symbols;
update the credit balance based on the award;
determine whether to continue the bonus feature based on the one or more credit symbols; and
issue a value based on the credit balance in response to a cash out request.

20. The non-transitory computer-readable storage device of claim 19, wherein
randomly determining the one or more credit symbols for the one or more symbol display areas of the plurality of the symbol display areas:
randomly selecting a first symbol for a first symbol display area of the plurality of the symbol display areas from a first set of symbols corresponding to the first symbol display area; and
converting the first symbol to a first credit symbol corresponding to a respective monetary award; and
displaying the one or more credit symbols in the one or more symbol display areas of the plurality of the symbol display areas comprises:
displaying the first symbol in the first symbol display area of the plurality of the symbol display areas; and
displaying the first symbol converted to the credit symbol in the first symbol display area of the plurality of the symbol display areas.
